(19) United States
(12) Patent Application Publication
(10) Pub. No.: US 2026/0036148 A1
(43) Pub. Date: Feb. 5, 2026

(54) LENS CONFIGURATION FOR RADAR SENSOR ASSEMBLY IN HYDRAULIC CYLINDERS

(71) Applicant: Pacoma GmbH, Eschwege (DE)

(72) Inventors: Guenter Leicht, Eschwege (DE); Karl-Wilhelm Herwig, Eschwege (DE)

(21) Appl. No.: 19/288,631

(22) Filed: Aug. 1, 2025

Related U.S. Application Data
(60) Provisional application No. 63/678,782, filed on Aug. 2, 2024.

(51) Int. Cl. F15B 15/28; F15B 15/14; G01S 7/02; G01S 13/08

(52) U.S. Cl. CPC F15B 15/2869; F15B 15/1438; G01S 7/027; G01S 13/08

(57) ABSTRACT

A hydraulic cylinder assembly includes a cylinder body, a piston configured to slide within an interior of the cylinder body, and a cylinder head coupled to the cylinder body. The cylinder head includes a cavity, and a bore that extends between the cavity and the interior of the cylinder body. The hydraulic cylinder assembly includes a radar sensing unit disposed within the cavity. The radar sensing unit includes a radar signal emitter and a radar signal detector oriented respectively to emit and detect radar signals through the bore into the interior of the cylinder body. The hydraulic cylinder assembly includes a dielectric lens between the radar sensing unit and the interior of the cylinder body, the dielectric lens having a convex side facing the radar sensing unit and a planar side opposite the convex side facing the interior of the cylinder body.

### CROSS-REFERENCE TO RELATED APPLICATIONS

This application claims priority to U.S. Patent Application Ser. No. 63/678,782, filed Aug. 2, 2024, the entire contents of which are incorporated herein by reference.

### TECHNICAL FIELD

This description generally relates to hydraulic cylinders, for example, used in machinery and/or construction equipment.

### BACKGROUND

Hydraulic cylinders are hydraulic actuators that provide linear motion for operation of machinery, including heavy machinery for applications in construction, automotive, agriculture, and other types of industrial applications. In use, hydraulic cylinders controllers apply different amounts of pressure to incompressible (or substantially incompressible fluids) of the hydraulic cylinder to generate the linear actuations from a piston and piston rod of the hydraulic cylinder. Precise control and alignment of the piston and piston rod depend on knowledge of the piston and piston rod's position within the hydraulic cylinder. In some cases, piston position and velocity has been measured using radar sensors that transmit radio waves and detect radio waves reflected off the piston or other structures within the cylinder. The quality of a radar measurement can depend on the amount and quality (e.g., signal-to-noise ratio) of radio waves captured by the sensor.

Hydraulic cylinders having such a radar sensor can include a collimator, such as a dielectric lens, that provides an interface between the cylinder body and head of the hydraulic cylinder where the sensor is located. The dielectric lens directs a path for electromagnetic waves to pass between the two parts of the hydraulic cylinder. The shape, material, and refractive index of a dielectric lens influence the path of electromagnetic waves transmitted in the hydraulic cylinder, but some dielectric lens designs do not incorporate dielectric medium differences. Some lenses are also composed of materials that are not well suited for industrial applications where a wide range of temperatures, pressures, vibrations, and the like may be experienced, thus degrading the quality and diminishing the number and quality of signals captured by the sensor.

### SUMMARY

This specification generally describes a dielectric lens configuration for hydraulic cylinders in which the dielectric lens is arranged in a sensor assembly block of the hydraulic cylinder to transmit and receive beams to and from a cylinder sensor system of the sensor assembly block. The dielectric lens is positioned in between the cylinder sensor system and the cylinder body of the hydraulic cylinder. The cylinder sensor system is configured to transmit and receive high-frequency electromagnetic signals to detect and measure the position of a piston within the body of a hydraulic cylinder assembly. In the case of radio frequency signals, the cylinder sensor system can be referred to as a “radar sensor unit,” or “radar sensor system.” The dielectric lens is configured to reduce signal losses that can degrade the signal processing capability of the cylinder sensor system, by accounting for differences in dielectric constants of ambient air on one side of the dielectric lens (e.g., facing the cylinder sensor system) and pressurized hydraulic fluid on the other side of the dielectric lens (e.g., facing the cylinder body of the hydraulic cylinder). The differences in dielectric constants from different mediums on either side of the dielectric lens, as well as variations in dielectric constant during use of the hydraulic cylinder can result in substantial signal loss and degrade the performance (e.g., tracking accuracy, velocity, and position estimation) of the cylinder sensor unit.

Embodiments of the dielectric lens described in this specification can be made of polyetheretherketone (PEEK) material, which allows the dielectric lens to withstand harsh environmental conditions experienced by hydraulic cylinders such as high temperatures, vibrations (e.g., shocks, and other types of forces). Changing environmental conditions can lead to changes in the dielectric constant of the lens, e.g., due to thermal expansion of the dielectric material, changes in the polarization of the dielectric material, mechanical stress applied to the material, or a combination of factors. A dielectric lens formed from PEEK material has a lower likelihood of contributing to lower signal losses for the cylinder sensor system, by providing increased rigidity to the structure of the dielectric lens while the dielectric lens is in the hydraulic cylinder and increasing resistance to environmental factors that would otherwise affect the dielectric constant.

Embodiments of the dielectric lens described in this specification can be shaped to achieve a target beam pattern for the cylinder sensor system that improves beam directivity for transmit and receive beams that propagate between the cylinder sensor system and the cylinder body. The dielectric lens can include a convex side facing the cylinder sensor system and a planar side opposite the convex side facing the interior of the cylinder body. The shape of the dielectric lens can allow for beams transmitted by the cylinder sensor unit to enter at the convex side of the dielectric lens at different incident angles, propagating through the dielectric lens such that the transmitted beams are substantially parallel to one another. The beams exit the dielectric lens at the planar side, which allows the beams remain substantially parallel to one another. When the transmitted beams illuminate objects in the cylinder body (e.g., the piston of the hydraulic cylinder), the resulting received beams (e.g., from reflection or refraction) of the detected object return to the dielectric lens substantially parallel to one another. The dielectric lens then allows for received beams entering the dielectric lens at the planar side to remain substantially parallel and exit at the convex side at a target angle for the received beams to be collected by the cylinder sensor system.

The dielectric lens achieves the target beam pattern through the shape of the lens, by directing transmit and receive beams for the cylinder sensor system in a way that increases the likelihood of transmitted signals arriving to the piston and increases the likelihood of any reflections or refractions resulting from the transmitted signals to return to the cylinder sensor system. The resulting increase in the number of detections generated from the return signals allows for a higher signal-to-noise ratio, thereby increasing the accuracy of the estimated position for the position. Improving the detectability, signal-to-noise ratio, and other signal processing characteristics of detected objects in the hydraulic cylinder can improve functionality of the hydraulic cylinder. An accurate estimate of the piston's state information allows for the hydraulic cylinder to be more precisely controlled. For example, hydraulic cylinder applications often demand precise control and using feedback mechanism based on a current or estimated position of the piston allows for a controller of the hydraulic cylinder to responsively and dynamically adjust piston actuation.

Further, the target beam pattern allows for the transmit and receive beams to be directed in a way that substantially reduces interference from noisy detections, e.g., refractions of electromagnetic energy returning from components of the hydraulic cylinder other than the piston. Maintaining a pattern of beams that are substantially parallel to one another provides uniform coverage of the cylinder body, reducing clutter in the detections resulting from the beams for the cylinder sensor unit. The target beam pattern allows for improvements in resolution of detections while the piston is at different positions in the cylinder body, as the substantially parallel beams are more likely to have predictable characteristics such as beamwidth, beam loss, etc. Furthermore, the dielectric lens provides a simple beam pattern that allows the cylinder sensor unit to leverage signal processing techniques with lower computational demands, such as beam forming, calibration, piston detection.

The dielectric lens configuration described in this specification includes a removeable dielectric lens with circumferential grooves that can be coupled to recesses of a removable sensor housing for containing the cylinder sensor system. Each of the circumferential grooves of the dielectric lens and each of the recesses of the sensor housing can have a shape that allows for a circumference groove of the dielectric lens to fit into a respective recess of the sensor housing. The dielectric lens can be coupled to the sensor housing of the cylinder sensor system by slidably connecting the circumferential grooves of the dielectric lens into the recesses of the sensor housing. The dielectric lens configuration also allows for the dielectric lens to be inserted into the bore of the hydraulic cylinder, and then the sensor housing to be inserted into a radial cavity of the hydraulic cylinder head. The grooves of the dielectric lens and recesses of the sensor housing can be slidably connected, and thus form a connection that helps to provide structural stability to the dielectric lens (e.g., from changing pressure in the cylinder body of the hydraulic cylinder).

The resulting improvement in stability allows for the dielectric lens to propagate waves more readily and efficiently (e.g., compared to other approaches for sensors in hydraulic cylinders) between the cylinder body and the cylinder head of the hydraulic cylinder, with resulting improvements in estimating the state information of the piston and piston rod in the hydraulic cylinder. Further, the disclosed dielectric lens configuration allows for clamping mechanisms between the dielectric lens and the sensor housing, to provide additional rigidity between contact surfaces of the dielectric lens and the sensor housing, including the cylinder sensor system. By securing contact surfaces between the dielectric lens and the sensor housing, the disclosed technology improves the alignment of the dielectric lens relative to the cylinder sensor system to reduce the effects of vibration and other forces on the dielectric lens. The disclosed technology improves the likelihood of achieving the target beam pattern produced by the dielectric lens, thereby increasing detection accuracy for the position, velocity, and other types of state information of the cylinder body components, such as the piston and the piston rod. The improved alignment and structural rigidity of the dielectric lens to the cylinder sensor system also results in a lower likelihood of clutter being generated, thus reducing extraneous consumptions of computer processing resources by the cylinder sensor system that would otherwise process detections associated with clutter.

In one aspect, a hydraulic cylinder assembly includes a cylinder body, a piston configured to slide within an interior of the cylinder body, a cylinder head coupled to a first end of the cylinder body, the cylinder head including a cavity and a bore that extends between the cavity and the interior of the cylinder body along a longitudinal axis. The hydraulic cylinder assembly includes a radar sensing unit disposed within the cavity of the cylinder head. The radar sensing unit includes a radar signal emitter and a radar signal detector oriented respectively to emit radar signals through the bore into the interior of the cylinder body and to detect reflected radar signals from the interior of the cylinder body indicative of a position of the piston. The hydraulic cylinder assembly includes a dielectric lens between the radar sensing unit and the interior of the cylinder body. The dielectric lens has a convex side facing the radar sensing unit and a planar side opposite the convex side facing the interior of the cylinder body.

In some implementations, the bore that extends between the cavity and the interior of the cylinder body along the longitudinal axis is an axial bore for insertion of the dielectric lens. The cavity can be a radial bore for insertion of the radar sensing unit.

In some implementations, the convex side of the dielectric lens is positioned adjacent to a first medium characterized by a first dielectric constant and the planar side of the dielectric lens is positioned adjacent to a second medium characterized by a second dielectric constant. In some implementations, the first medium is air and the second medium is a hydraulic fluid.

In some implementations, the radar sensing unit includes one or more radar sensors configured to transmit and receive radio frequency (RF) signals.

In some implementations, the dielectric lens includes polyether ether ketone (PEEK) material.

In some implementations, the radar signal emitter is configured to emit a transmit beam along a transmit beam path between the radar signal emitter and the dielectric lens. The transmit beam can enter the dielectric lens at a first incident angle at the convex side of the dielectric lens and the dielectric lens can cause the transmit beam to refract at a second incident angle. The second incident angle can allow the transmit beam to exit the dielectric lens along an axis substantially parallel to a longitudinal center axis of the dielectric lens.

In some implementations, the dielectric lens is configured to refract a receive beam along a receive beam path between the cylinder body and the dielectric lens. The receive beam can enter the dielectric lens at a third incident angle at the planar side of the dielectric lens, and the dielectric lens can cause the receive beam to refract at a fourth incident angle. The third incident angle can be substantially perpendicular to the planar side of the dielectric lens, and the fourth incident angle can allow the receive beam to exit the dielectric lens at an angle to be received by the radar signal detector.

In some implementations, the radar sensing unit further includes a sensor housing that encloses the radar sensing unit. The sensor housing includes an opening to receive the dielectric lens by inserting the dielectric lens into the bore that extends between the cavity and the interior of the cylinder body along the longitudinal axis. In some implementations, the sensor housing includes one or more recesses. The dielectric lens can include one or more circumferential grooves, each recess from the one or more recesses of the sensor housing containing a shape that fits to the one or more circumferential grooves of the dielectric lens.

In some implementations, the dielectric lens is configured to be inserted into the sensor housing by sliding the one or more circumferential grooves of the dielectric lens into the one or more recesses of the sensor housing. In some implementations, the sensor housing includes one or more clamping mechanisms configured to hold the one or more circumferential grooves of the dielectric lens into the one or more recesses of the sensor housing.

In some implementations, the hydraulic cylinder assembly includes a spacer having a first end and a second end opposite the first end, the spacer coupled to the cylinder head at the first end and coupled to the sensor housing at the second end. The sensor housing encloses the radar sensing unit. The hydraulic cylinder assembly can include a gasket that aids in securing the spacer to the cylinder head. The gasket can be an O-ring.

In some implementations, the spacer includes a cylindrical internal portion having at least two grooves. Each of the at least two grooves is configured to receive the gasket. The gasket is configured to form a face seal between a first groove from the at least two grooves and an inner surface of the spacer when the gasket is disposed onto the first groove. The gasket is configured to allow rotation of the cylinder head when the gasket is disposed onto a second groove from the at least two grooves. The second groove is different than the first groove.

In some implementations, the spacer includes one or more openings disposed through a thickness of the spacer. Each of the one or more openings being located at a position on an outer surface of the spacer to provide access to the at least two grooves.

In some implementations, the spacer includes a connector configured to electrically couple the radar sensing unit to a housing connector of the cylinder head.

In another aspect, a radar assembly for a hydraulic cylinder includes a housing, a radar signal emitter disposed within the housing and configured to emit radar signals toward an interior of a hydraulic cylinder body when the radar assembly is installed in a hydraulic cylinder head of the hydraulic cylinder, a radar signal detector disposed within the housing and configured to detect reflected radar signals from the interior of the hydraulic cylinder body when the radar assembly is installed in the hydraulic cylinder head of the hydraulic cylinder, and a dielectric lens having (i) a convex side that faces the radar signal emitter and the radar signal detector when the radar assembly is installed in the hydraulic cylinder head and (ii) a planar side that faces the interior of the hydraulic cylinder body when the radar assembly is installed in the hydraulic cylinder head.

In some implementations, the housing includes one or more recesses, and the dielectric lens further includes one or more circumferential grooves. Each recess from the one or more recesses of the sensor housing containing a shape that fits to the one or more circumferential grooves of the dielectric lens. In some implementations, the dielectric lens is configured to be inserted into the housing by sliding the one or more circumferential grooves of the dielectric lens into the one or more recesses of the sensor housing. In some implementations, the housing includes one or more clamping mechanisms configured to hold the one or more circumferential grooves of the dielectric lens into the one or more recesses of the sensor housing.

In another aspect, a hydraulic cylinder assembly includes a cylinder body, a piston configured to slide within an interior of the cylinder body, a cylinder head coupled to a first end of the cylinder body, the cylinder head includes a cavity and a bore that extends between the cavity and the interior of the cylinder body along a longitudinal axis. The hydraulic cylinder assembly includes a radar sensing unit disposed within the cavity of the cylinder head. The radar sensing unit includes a radar signal emitter and a radar signal detector oriented respectively to emit radar signals through the bore into the interior of the cylinder body and to detect reflected radar signals from the interior of the cylinder body indicative of a position of the piston. The hydraulic cylinder assembly includes a removable dielectric lens between the radar sensing unit and the interior of the cylinder body. The removable dielectric lens includes one or more circumferential grooves. The hydraulic cylinder assembly includes a removable sensor housing containing the radar sensing unit and having one or more recesses, each recess from the one or more recesses of the removable sensor housing containing a shape that fits to the one or more circumferential grooves of the removable dielectric lens. The one or more recesses are configured to slidably connect with the one or more circumferential grooves of the removable dielectric lens. The removable sensor housing can repeatedly position the radar sensing unit a particular distance from the removable dielectric lens.

In some implementations, the removable sensor housing includes an opening to receive the removable dielectric lens. In some implementations, the removable dielectric lens is configured to be slidably connected to the removable sensor housing, by placing the one or more circumferential grooves of the removable dielectric lens into the one or more recesses of the removable sensor housing and sliding the one or more circumferential grooves of the removable dielectric lens into the one or more recesses of the removable sensor housing.

In some implementations, the removable sensor housing includes one or more clamping mechanisms configured to hold the one or more circumferential grooves of the removable dielectric lens into the one or more recesses of the removable sensor housing.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF DRAWINGS

FIG. 1A is a side view of a hydraulic cylinder including a sensor assembly block, including a sensor unit and a dielectric lens.

FIG. 1B is a close-up, cross-sectional view of the hydraulic cylinder and the sensor assembly block of FIG. 1A.

FIG. 2A shows an example ray pattern for a planar-convex dielectric lens.

FIG. 2B shows an example ray pattern for a convex-planar dielectric lens.

FIG. 3 is an exploded view of the sensor assembly block of FIGS. 1A and 1B.

FIG. 4A is a close up view of a sensor housing unit and a dielectric lens for the sensor assembly block of FIGS. 1A, 1B, and 3.

FIG. 4B shows a front view of a sensor unit, including a sensor unit housing.

FIG. 4C is a close-up, cross-sectional view of the sensor assembly block of FIGS. 1A, 1B, and FIG. 3.

FIG. 5 shows a bottom view of the sensor unit of FIGS. 3, and 4A through 4C.

FIG. 6 shows a dielectric lens.

FIG. 7 is a cross-sectional view of another example sensor assembly block.

FIG. 8 is an exploded view of the sensor assembly block of FIG. 7.

FIG. 9 is a close up view of a sensor housing unit, spacer, and a dielectric lens for the sensor assembly block of FIGS. 7 and 8.

FIG. 10A shows a close-up view of the spacer and a top view of the sensor housing unit, of FIGS. 7, 8, and 9.

FIG. 10B shows a cross-sectional view of the spacer and the sensor housing unit of FIG. 10A.

Like reference numbers and designations in the various drawings indicate like elements.

### DETAILED DESCRIPTION

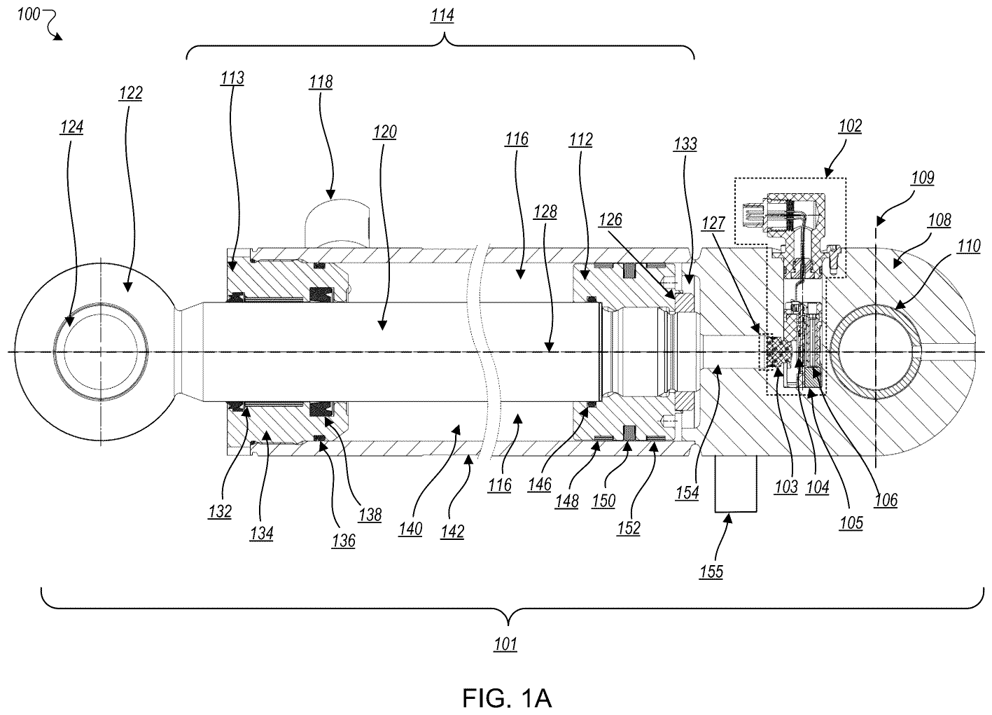

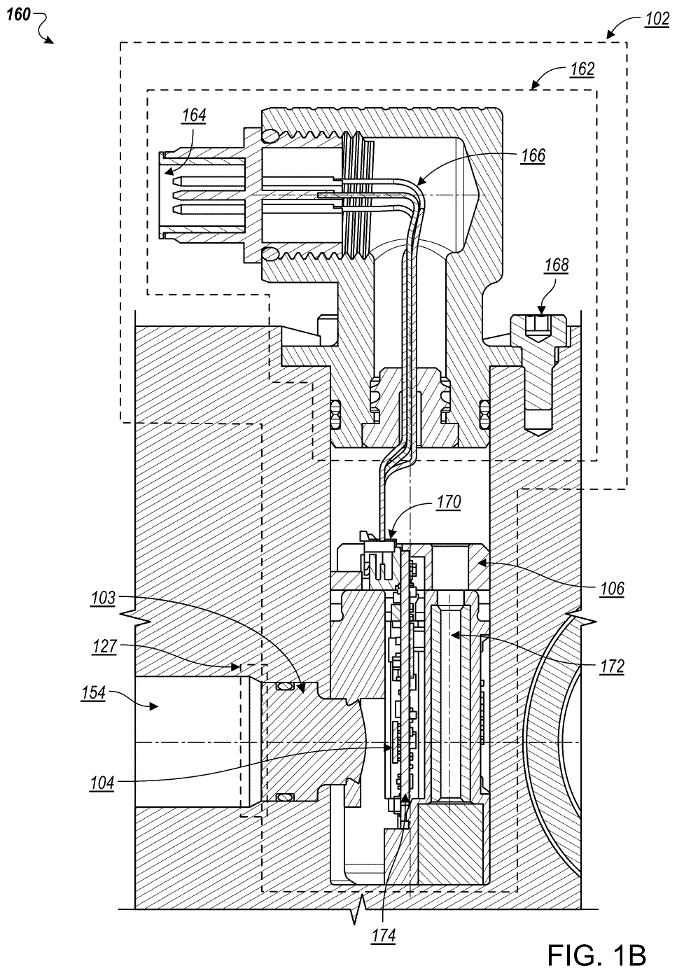

FIG. 1A is a cross-section view 100 of a hydraulic cylinder 101, which includes a sensor assembly block 102 that further includes a dielectric lens 103 and cylinder sensor unit 104. The hydraulic cylinder 101 includes a cylinder head 108 at a first end of the hydraulic cylinder 101 (e.g., depicted on the right-hand side of the page), and includes a piston rod eye 122 at a second end of the hydraulic cylinder 101 (e.g., opposite the first end of the hydraulic cylinder, on the left-hand side of the page). The cylinder head 108 includes a bearing bushing 110 arranged in an area of the cylinder head 108, and the piston rod eye 122 includes bearing bushing 124 arranged in an area of the piston rod eye 122. Each of the bearing bushings 110, 124 facilitate connections between the hydraulic cylinder 101 and a machine, e.g., to provide motion for the machine. FIG. 1A also shows a longitudinal center axis 128 (also referred to as “longitudinal axis 128” or “axis 128”) is illustrated as a dashed line across the length of the hydraulic cylinder 101 as a reference for the insertion of components into portions of the hydraulic cylinder 101. For example, a cylinder sensor unit 104 can be inserted into the cylinder head 108 by a sensor mounting bore 105 (also referred to as a “cavity 105”). The sensor assembly block 102 can be inserted radially into the cavity 105 of the cylinder head 108.

The cylinder head 108 is coupled to a cylinder body 114, which further includes a cylinder housing 142 (also referred to as “housing 142”). The housing 142 is configured to house the components of the cylinder body 114, such as a piston 112, piston rod 120, etc. The piston 112 is connected to a piston rod 120, in which the piston rod eye 122 is arranged at the second end of the hydraulic cylinder 101. The housing 142 can be sealed, e.g., hermetically, using a number of components (e.g., mechanical gaskets, seals, rings) to maintain pressure inside of the hydraulic cylinder 101. In some implementations, the hydraulic cylinder 101 is referred to as a piston and cylinder unit 101.

The piston 112 effectively separates an interior of the cylinder body 114 into a pair of pressure chamber 116 and 133 on either side of the piston 112. The interior of the cylinder body 114 can be filled with a hydraulic fluid via port 118. For example, pressure chamber 116 is illustrated adjacent and to the left of the piston 112, whereas pressure chamber 133 is illustrated to the right of the piston 112. The pressure chamber 116 is formed in the interior of the cylinder body 114 and surrounds the piston rod 120. Referring to ports 118 and 155 of the hydraulic cylinder, the ports can be filled with hydraulic fluid to generate different amounts of pressure to generate motion for the piston. Port 118 can be configured to fill the pressure chamber 116, while port 155 can be configured to fill the pressure chamber 133.

For example, a hydraulic circuit (not illustrated in FIG. 1A), with a hydraulic pump and changeover valves is connected to the port 118 and/or port 155 to allow exchange of hydraulic fluids and generate different amounts of pressure. For example, depending the pressure generated by means of the hydraulic circuit at the port 118 and/or the port 155, an actuating force can be generated hydraulically with both directions along the longitudinal center axis 128, which acts on the piston 112, and with the resulting actuating movement of the piston 112, a change in the volume of the pressure chambers 116 and 133.

Although FIG. 1 shows the piston 112 and the piston rod 120 in a fully retracted position within the cylinder body 114, the piston 112 and the piston rod 120 can also be extended by sliding along the longitudinal center axis 128. As the piston 112 slides along longitudinal axis 128, the relative sizes of the pressure chambers 116 and 133 on either side of the piston 112 will correspondingly change based on the position of piston 112 within the cylinder body 114. A rod seal 138 and an O-ring 136 are provided for storage and sealing at a bottom portion of the cylinder body 114. The bottom portion of the cylinder body 114 also includes a slide bearing 132 to support sliding motions of the piston rod 120. The cylinder body 114 includes a guide bushing 113 on a front portion of the cylinder body 114 (e.g., left hand side of the page) to stabilize and guide the movement of the piston rod 120 within the cylinder body 114, by stabilizing the piston rod as extends and retracts in the cylinder body 114.

The piston 112 is rotationally fixed to the piston rod 120 and secured by means of a lock nut 126. Furthermore, an O-ring 146, a piston guide ring 148, a piston seal 150, and a further piston guide ring 152 are arranged on the piston 112. In this way, piston 112, piston rod 120, and piston rod eye 122 form a slidable unit along axis 128 while maintaining a seal between pressure chambers 116, 133. To the right of the pressure chamber 133 (e.g., enclosed by the cylinder housing 142), a partial chamber 154 of the pressure chamber 133 in the cylinder head 108 connects the cylinder head 108 to the cylinder body 114. The partial chamber 154 includes an axially extending sensor signal channel 127, shown in FIG. 1A as part of the pressure chamber 133 and thus exposed to hydraulic fluid. The sensor signal channel 127 is in turn connected to the cavity 105, which extends radially relative to the longitudinal center axis 128 in the cylinder head 108. The cavity 105 extends to the outer surface of the cylinder head 108 and can be connected to the environment by means of an unillustrated compensation hole. The sensor signal channel 127 is adjacent to the dielectric lens 103, to facilitate propagation of electromagnetic beams between the cylinder body 114 and the cylinder sensor unit 104 of the sensor assembly block 102.

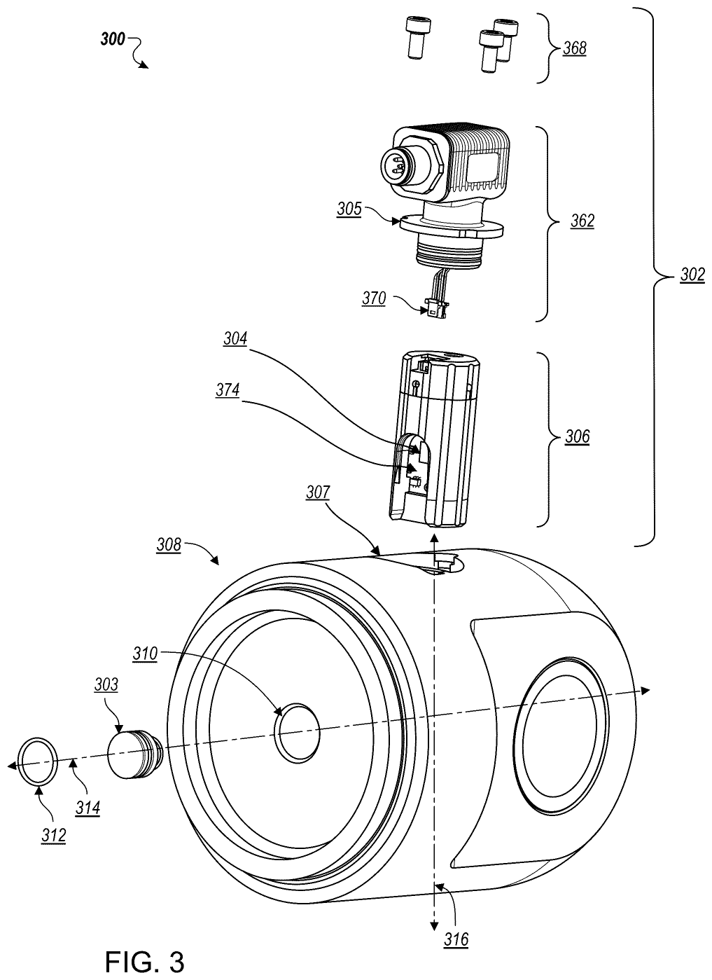

FIG. 1B is a close-up, cross-sectional view 160 of the hydraulic cylinder 101 and the sensor assembly block 102 of FIG. 1A (also referred to as a “sensor block 102”). The sensor block 102 is arranged in the cavity 105, such that the cylinder sensor unit 104 (also referred to as a “piston position detection unit 104” or “sensor unit 104”) can be used to detect the axial position of the piston 112 and/or the piston rod 120 in the cylinder body 114 using high-frequency technology (e.g., using radar signals). As described in reference to FIG. 3 below, the sensor block 102 can include a housing for the sensor unit 104, e.g., to secure the sensor unit 104 in the cavity 105.

The sensor unit 104 can be a radar sensing unit that includes one or more radar sensors and/or emitters configured to emit radar signals into the cylinder body 114 and detect reflected radar signals. The sensor unit 104 sends out a high-frequency signal, which hits the end face of the piston 112 or the piston rod 120 through the sensor signal channel 127 and through the partial chamber 154 as well as through the pressure chamber 133 and, after reflection through this end face, returns to the sensor unit 104.

The movement of the signal, in particular the path traveled by the end face, can then be determined from the reflected signal using high-frequency technology, in particular by evaluating the transit time. For example, an electronic unit connected to or included in the sensor unit 104 (including electronic components and software executed by these components) can carry out an evaluation of the reflected signals to determines the current position of the piston 112 along the longitudinal center axis 128. This determination can be conducted at a single time instance, in defined time intervals, continuously, or at specific points in time. In some implementations, the result or a command being associated with the result is transmitted to an electronic computing unit of the working machine connected therewith—a part of which is the hydraulic cylinder 101.

The sensor unit 104 can be used to directly measure the stroke of the piston 112 or the piston rod 120 within the cylinder body 114. The sensor unit 104 is preferably based on a non-contact measuring radar system in which the transit time between a transmitting unit and the end face of the piston 112 or the piston rod 120 and the reflected signal received at a receiving unit is evaluated. The position and/or speed of the piston 112 can then be determined from the transit time with high accuracy and robustness. For example, the sensor unit 104 can be used to determine a stroke that is in the range of 10 mm to 2,000 mm, for example 30 mm to 1,800 mm or 40 mm to 1,600 mm. Here, for example, a radar detection resolution in the range of 0.2 mm to 4 mm, for example 0.5 to 2 mm or 0.8 to 1.5 mm, can be achieved.

The sensor block 102 can include a sensor housing 106 that includes the sensor unit 104 coupled to the dielectric lens 103. The sensor block 102 can be positioned in the cavity 105 to form a seal that prevents hydraulic fluid from escaping, e.g., from the partial chamber 154 into the sensor unit 104. The seal can be formed between the partial chamber 154 and the dielectric lens 103, and between the dielectric lens 103 and the sensor housing 106.

The dielectric lens 103 is configured to direct high-frequency signals in a way that improves measurement accuracy of the sensor unit 104. The dielectric lens 103 can be formed such that beams that were previously non-parallel beams (e.g., from divergent sources) can be made parallel to one another, e.g., converting parallel beams to non-parallel beams and vice-versa. For example, the sensor unit 104 can transmit beams from a central point (e.g., a transmitter or transceiver of the sensor unit) to a front side of the piston 112 and/or the piston rod 120. The dielectric lens 103 converts the non-parallel beams into a set of parallel beams while the beams propagate through the dielectric lens 103, such that the beams exit through the dielectric lens substantially parallel, e.g., relative to one another. Upon the beams illuminating parts of the cylinder body 114, the resulting return signals (e.g., including information for forming detections by the sensor unit) are reflected back into parallel beams. The dielectric lens 103 can be configured to receive the return signals at substantially parallel beams and bundle the beams back to a central point of the sensor unit 104, e.g., a receiver or transceiver of the sensor unit.

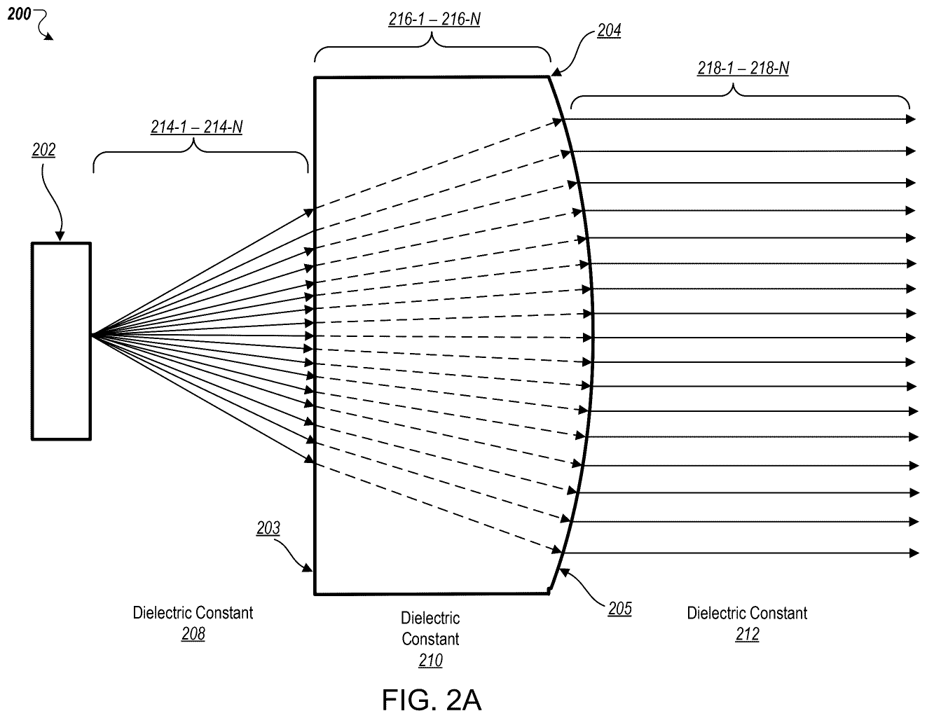

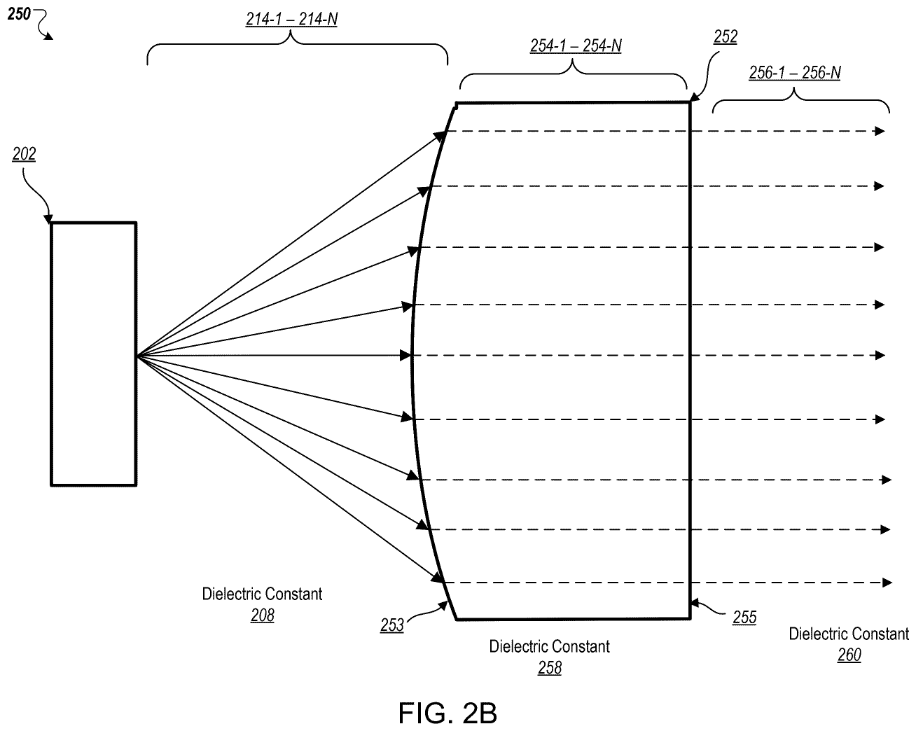

In some implementations, the dielectric lens 103 can be configured (e.g., based on the material and/or shape) to serve as a filter that focuses on a target range of beams, such as high-frequency beams or substantially high-frequency beams for the sensor unit, e.g., beams that have propagated through the dielectric lens at a substantially parallel angle and to the longitudinal center axis 128. This allows high-frequency radiation to be filtered out that does not originate, or at least does not originate directly from an end of the piston 112 and/or piston rod 120. A source of clutter from the receive signals can result from the fact the refraction/reflection of beams may not be ideal, e.g., beams transmitted and/or received may not occur punctually or surfaces may not be ideally flat. Further detail of the radiation pattern for the beams is described in reference to FIGS. 2A and 2B below.

The dielectric lens 103 can be made up or have a dielectric plastic or a dielectric ceramic, polytetrafluoroethylene, polyethylene or polypropylene. The dielectric lens 103 preferably has a dielectric constant (permittivity) greater than that of air and greater than that of the hydraulic fluid in the piston-cylinder unit. For example, the permittivity can be between 20% and 50% greater than that of the hydraulic fluid in the cylinder body 114. The permittivity difference and the curvature of the dielectric lens are coordinated. In some implementations, the dielectric lens 103 may be formed by the sensor block 102 or by the sensor unit 104 itself, although the sensor housings can be structurally separated.

FIG. 1B also illustrates a housing connector 170 for carrying electrical signals, such as a pico-clasp plug that can be used to connect a housing plug 162 to the sensor unit 104, e.g., by mounting the sensor unit 104 onto a substrate 174 and coupling the housing connector 170 to the substrate 174. For example, the substrate 174 can include one or more ports configured to receive the housing connector 170. The substrate 174 can include one or more electrical components mounted on a surface of the substrate 174, embedded in the substrate 174, etc. In some implementations, the substrate 174 is a printed circuit board (PCB), with a number of electrical components mounted on the PCB. Examples of additional components can include various power stage components such as amplifiers, current/voltage regulators and converters, etc.

The sensor block 102 can include the housing plug 162 with a number of components that facilitate connections to and from a device for providing control to the hydraulic cylinder, e.g., a computing device. For example, the housing plug 162 includes a connector plug 164 to couple to a connector cable from a device to provide signals to the sensor unit 104. The sensor block 102 can include a housing connector 170 that attaches to the sensor unit 104 (e.g., through the housing connector 170 coupled to the substrate 174, where the sensor unit 104 is mounted) using a number of wires 166. In some cases, the housing connector 170 can be coupled to the sensor unit 104, prior to the insertion of the sensor unit 104 into the cavity 105. In some implementations, the connector plug 164 is an M12 connector, although any other type of hydraulic cylinder connector configured to carry to provide signals may be utilized.

The housing plug 162 includes a number of pins, e.g., ground, DC voltage, analog signal, high-speed bus, low-speed bus for communication to and from the sensor unit 104 and other devices. For example, the housing plug 162 can use an analog signal to provide pulse-width modulated pulses or voltage signals. The sensor block 102 can include one or more fixing screws 168 to affix the housing plug 162 to the cylinder head 108. The sensor block 102 also includes a threaded pipe 172 which can be used to align the position of the sensor housing 104 in the cavity 105.

FIG. 2A shows an example ray pattern 200 for a planar-convex dielectric lens 204 (also referred to as “dielectric lens 204”), in which the ray pattern 200 shows beams propagating through the dielectric lens 204. FIG. 2A shows a sensor unit 202, e.g., an example of sensor unit 104 described in reference to FIG. 1A above and illustrates the path of beams (a beam path or beam pattern) from the left side of the page to the right side of the page.

The sensor unit 202 is configured to transmit a number of beams 214-1 through 214-N (collectively referred to as “transmit beams 214”) to the dielectric lens 204. As illustrated in FIG. 2A, the ray pattern 200 shows the transmit beams 214 passing through a first dielectric constant 208 of a first medium (e.g., air) to the left of the dielectric lens 204 and entering the dielectric lens 204 at a first interface 203. The first interface 203 is illustrated in FIG. 2A as having a substantially flat shape. The first medium between the sensor unit 202 and the dielectric lens 204 has the first dielectric constant 208, e.g., a value of close to one or approximately one (e.g., a dimensionless quantity). The first interface 203 can be referred to as the planar side of the dielectric lens 204 and faces the sensor unit 202 to receive the transmit beams 214. The first interface 203 and the second medium with the second dielectric constant 210 of the dielectric lens 204 cause the transmit beams 214 to bend (e.g., refract, reflect) into the beam pattern illustrated by beams 216-1 through 216-N (collectively “beams 216,” and also referred to as “refracted beams 216.”) The second dielectric constant 210, also referred to as the dielectric constant or the relative permittivity of the dielectric lens 204, is based on the materials used for the dielectric lens 204, e.g., the second medium. For example, the material of the dielectric lens can be polyether ether ketone (PEEK) material, which can have a dielectric constant in a range between 2.8 and 3.2, though other values may be appropriate. In some implementations, the material of the dielectric lens can be polyetherketoneketone (PEKK) and/or another type of material in the polyaryletherketones (PAEK) family of materials.

The refracted beams 216 exit the dielectric lens 204 at a second interface 205, illustrated in FIG. 2A as having a substantially convex shape. The second interface 205 can be referred to as the convex side of the dielectric lens 204 and faces the cylinder (e.g., cylinder body 114 of FIG. 1A) of a hydraulic cylinder (e.g., hydraulic cylinder 101 of FIG. 1A). The beams 216 exit the dielectric lens 204 as exit beams 218-1 through 218-N (collectively “exit beams 218”) through a third dielectric constant 212 of a third medium. The exit beams 218 are illustrated as being substantially parallel to one another when exiting the second interface 205 of the dielectric lens 204. In this way, the exit beams 218 propagate through the cylinder body of a hydraulic cylinder in a direction parallel to a longitudinal center axis of the cylinder body. The exit beams 218 propagate through the third dielectric constant 212 of the third medium, the third medium being hydraulic oil or another type of hydraulic fluid used in the hydraulic cylinder to actuate the piston. The dielectric constant can range from 2.1 to 2.5 in reflective permittivity of hydraulic oil. The type of oil/fluid, as well as related chemical and/or physical properties of the oil/fluid using the hydraulic cylinder can result in variations in the dielectric constant 212. In some cases, pressure and temperatures experienced by the hydraulic cylinder can cause fluctuations or variations in the dielectric constant of the different mediums, e.g., the air at the interfaces of the dielectric lens, the dielectric lens itself, the hydraulic oil in the hydraulic cylinder . . . .

Any beam from the exit beams 218 that illuminate, refract, reflect, or becomes incident to the piston in the cylinder body can be reflected back along the ray pattern 200 back to the sensor unit 202 (e.g., from right to left of the page for FIG. 2A). The received signals from detections of the piston or other objects in the cylinder body can be processed by the sensor unit 202 to determine state information, e.g., position, velocity, acceleration (among others) of the detected object.

The ray pattern 200 shows the sensor unit 202 configured to emit a transmit beam along a transmit beam path (e.g., the ray pattern 200) between a radar signal emitter of the sensor unit 202 and the dielectric lens 204. A transmit beam of the transmit beams 214 can enter the dielectric lens 204 at a first incident angle at the first interface 203 of the dielectric lens, e.g., the planar side of the dielectric lens. The dielectric lens causes the transmit beam from transmit beams 214 to refract at a second incident angle at the second interface 205, e.g., the convex side of the dielectric lens. For example, the transmit beam 214 is refracted into a refracted beam 216 and exits the dielectric lens at the second incident angle at the second interface 205, thereby allowing the exit beam (e.g., the refracted transmit beam) to exit the dielectric lens along an axis substantially parallel to a longitudinal center axis of the dielectric lens. This axis can also additionally or alternatively be substantially parallel to a longitudinal center axis of the hydraulic cylinder and/or cylinder body.

Any rays reflected or refracted from a detected object in the cylinder body can referred to as a receive beam that propagates along a receive beam path (from right to left of the page for FIG. 2A) between the cylinder body and the dielectric lens 204. For example, the receive beam enters the dielectric lens 204 at a third incident angle of the second interface 205, e.g., the convex side of the dielectric lens 204, in which the third incident angle is not substantially perpendicular to the convex side of the dielectric lens and refracts the received beams at a non-perpendicular angle, e.g., obtuse. The dielectric lens 204 causes the receive beam to refract at a fourth incident angle at the first interface 203 that allows the receive beam to exit the dielectric lens 204 at an angle to be received by the sensor unit 202 at a common point, e.g., a signal detector, for signal processing.

In some cases, the sensor unit 202 can be a radar sensor unit 202 (also referred to as a “radar sensor system 202”) that can include one or more radar sensors configured to transmit and receive radio frequency (RF) signals. The radar sensor unit 202 can be configured to transmit signals within particular frequency ranges. Examples of frequency ranges can include high frequency (e.g., 3 MHz to 30 MHZ), very high frequency (e.g., 30 MHz to 300 MHZ), and ultra-high frequency (e.g., 300 MHz to 300 GHz), among others.

FIG. 2B shows an example ray pattern 250 for a convex-planar dielectric lens 252 (also referred to as “dielectric lens 252”), in which the ray pattern 250 shows beams propagating through the dielectric lens 252. Similar to FIG. 2A, FIG. 2B shows the sensor unit 202 and illustrates the path of beams (a beam path or beam pattern) from the left side of the page to the right side of the page. The sensor unit 202 emits transmit beams 214 to the dielectric lens 252 through the first dielectric constant 208. In contrast to the ray pattern 200 of FIG. 2A, the ray pattern 250 shows the transmit beams 214 passing through the first medium with the first dielectric constant 208 and entering the dielectric lens 252 at a first interface 253, illustrated as having a substantially convex shape. The first interface 253 can be referred to as the convex side of the dielectric lens 252 and faces the sensor unit 202 to receive the transmit beams 214. The first interface 253 and the second dielectric constant 258 of the dielectric lens 252 cause the transmit beams 214 to bend (e.g., refract, reflect) into the beam pattern illustrated by parallel beams 254-1 through 254-N (collectively “parallel beams 254,” and also referred to as “refracted parallel beams 254.”) The second dielectric constant 258, also referred to as the dielectric constant or the relative permittivity of the dielectric lens 252, is based on the materials used for the dielectric lens 252.

Similar to FIG. 2A, the material of the dielectric lens 252 can be polyether ether ketone (PEEK) material, e.g., having a dielectric constant in a range between 2.8 and 3.2. The dielectric lens 252 can also have a thickness that is non-uniform relative to a longitudinal center axis of the dielectric lens, e.g., the thickness of the lens varies across the dielectric lens. In some cases, the dielectric lens is an aspheric lens, e.g., having a non-spherical profile to correct for optical aberrations. In some implementations, the aspheric lens can reduce aberrations such as spherical aberration (e.g., reducing focal differences throughout different portions of the lens), coma (e.g., off-axis aberrations), and astigmatism (e.g., blurring). These aberrations can result in reduced signal quality and thus reduce accuracy of detections from detected objections. Thus, an aspheric lens used for the dielectric lens configuration shown in FIG. 2B can provide improved sensor measurement quality, e.g., by reducing aberrations that reduce signal detection quality.

In contrast to FIG. 2A, the refracted beams 254 propagating through the dielectric lens 252 are substantially parallel, e.g., to a longitudinal center axis of dielectric lens 252 and/or the cylinder body adjacent to the dielectric lens 252. Thus, the parallel beams 254 exit the dielectric lens 252 at a second interface 255 having a substantially planar shape, e.g., the planar side of the dielectric lens 252, and allows the beams to propagate into a third medium having the third dielectric constant 260 as parallel exit beams 256-1 through 256-N (collectively “parallel exit beams 256”). By parallelizing beams earlier in the propagation of the beam pattern, the dielectric lens 252 is more likely to maintain a parallel beam pattern between the sensor unit 202 and objects in the cylinder body of the hydraulic cylinder. Increasing the duration of time that beams stay parallel in propagation increases the likelihood of detections being reflected back from the piston to the sensor unit 202.

The second interface 255 faces the cylinder (e.g., cylinder body 114 of FIG. 1A) of a hydraulic cylinder (e.g., hydraulic cylinder 101 of FIG. 1A), and the exit beams 256 are illustrated as being substantially parallel to one another when exiting the second interface 255 of the dielectric lens 252. In this way, the exit beams 256 propagate through the cylinder body of a hydraulic cylinder in a direction parallel to a longitudinal center axis of the cylinder body. The exit beams 256 propagate through the third dielectric constant 260 of a third medium, e.g., hydraulic oil used in the hydraulic cylinder to actuate the piston. Similar to FIG. 2A, a beam from the exit beams 256 that illuminate, refract, reflect, or becomes incident to the piston in the cylinder body can be reflected back along the ray pattern 250 back to the sensor unit 202 (e.g., from right to left of the page for FIG. 2B). The received signals from detections of the piston or other objects in the cylinder body can be processed by the sensor unit 202 to determine state information, e.g., position, velocity, acceleration (among others) of the detected object.

The ray pattern 250 shows the sensor unit 202 configured to emit a transmit beam along a transmit beam path (e.g., the ray pattern 250) between a radar signal emitter of the sensor unit 202 and the dielectric lens 252. A transmit beam of the transmit beams 214 can enter the dielectric lens 252 at a first incident angle at the first interface 253 of the dielectric lens, e.g., the convex side of the dielectric lens. The first interface 253 and the dielectric constant 258 of the dielectric lens 252 cause the transmit beams 214 to bend (e.g., refract, reflect) into the beam pattern illustrated by parallel beams 254-1 through 254-N (collectively, “parallel beams 254,” also referred to as “refracted parallel beams 254”). The parallel beams 254 exit the dielectric lens 252 at the second interface 255, e.g., the planar side of the dielectric lens, at a second angle of incidence that maintains the beams in a substantially parallel path as parallel exit beams 256. The parallel exit beams 256 exit the dielectric lens 252 at the second interface 255 along an axis substantially parallel to a longitudinal center axis of the dielectric lens. This axis can also additionally or alternatively be substantially parallel to a longitudinal center axis of the hydraulic cylinder and/or cylinder body.

Any rays reflected or refracted from a detected object in the cylinder body can referred to as a receive beam that propagates along a receive beam path (from right to left of the page for FIG. 2B) between the cylinder body and the dielectric lens 252. For example, the receive beam enters the dielectric lens 252 at a third incident angle of the second interface 255, e.g., the planar side of the dielectric lens 252, in which the third incident angle is substantially perpendicular to the planar side of the dielectric lens. The receive beams can be substantially parallel to a longitudinal center axis of the dielectric lens 252 and/or substantially parallel to a longitudinal center axis of the cylinder body. The dielectric lens 252 causes the receive beam to refract at a fourth incident angle at the first interface 253 that allows the receive beam to exit the dielectric lens 252 to converge at the sensor unit 202.

The dielectric lens configuration depicted in FIG. 2B can be a preferred implementation that improves convergence of received beams, e.g., compared to the configuration depicted in FIG. 2A. For example, while the configuration depicted in FIG. 2A may be able to converge at or within a threshold distance of a single point of the sensor unit 202, the non-parallel nature of the refracted beams as they propagate through the dielectric lens 204 can result in a loss of detections by spreading beams away from the beam path (e.g., diluting radiated energy) and lowering the radar cross-section, signal-to-noise ratio, and other signal properties. Non-parallel beams are also more likely to scatter, reflect, and cause types of interference, and can also result in multiple beams paths that interfere with one another, e.g., phase delay, and thus result in destructive interference. Thus, by parallelizing beams earlier in propagation and reducing the number of instances in which the beams can be inadvertently refracted, the dielectric lens configuration depicted in FIG. 2B can increase the RCS, SNR, and other signal characteristics of detected objects. The configuration of the dielectric lens can be planar-convex, convex-planar, can also be planar-planar, or any combination of planar, convex, concave, or other shapes.

FIG. 3 is an exploded view 300 of the sensor assembly block 302 (also referred to as “sensor block 302”), which is an example of the sensor block 102 of FIGS. 1A and 1B. The exploded view 300 shows the sensor block 302 having with a housing plug 362, which can be affixed to cylinder head 308 by a number of fixing screws 368, e.g., similar to fixing screws 168 described in reference to FIG. 1B above. For example, the housing plug 362 can include a plate 305 with a number of openings disposed through a thickness of the plate 305. The plate can be formed from the same body of the housing plug 362 but can also be an additional component attached to the housing plug 362. Each fixing screw 368 can be disposed through an opening of the plate, to secure the housing plug 362 to the cylinder head 308, e.g., by placing the fixing screw 368 into an opening disposed in a surface of the cylinder head 308.

The cylinder head 308 also include a sensor unit opening 307 (also referred to as a “sensor unit cavity 307”), which is an opening disposed through a thickness of the cylinder head 308, e.g., to form a cavity, to allow for a sensor housing unit 306 (e.g., an example of sensor housing unit 106 of FIGS. 1A and 1B) to be inserted. The sensor housing unit 306 can include a sensor unit 304, similar to sensor unit 104 as described in reference to FIGS. 1A and 1B above. The sensor unit 304 is shown to be mounted onto a substrate 374, e.g., an example of a substrate 174 (such as a printed circuit board) described in reference to FIG. 1B above. The sensor housing unit 306 can be coupled to the housing plug 362 by the housing connector 370, e.g., similar to housing connector 170 of FIG. 1B. A housing connector 370 can be configured to attach the sensor housing unit 306 to the housing plug 362 by wires configured to communicate signals between the sensor unit 304 and a data port of the housing plug 362, e.g., to provide signals to a computing device, machine, or some combination thereof, coupled to the hydraulic cylinder. The sensor housing unit 306 includes a sensor unit 304, similar to the sensor unit 104 described in reference to FIGS. 1A and 1B above but can also be an example sensor unit 202 described in reference to FIGS. 2A and 2B above. The housing connector 370 can be used to couple the sensor housing unit 306 to the housing plug 362 prior to the insertion of the sensor housing unit 306 into a cavity of the cylinder head 308.

As illustrated in FIG. 3, the housing plug 362 can include a number of grooves and/or corresponding O-rings to form a seal between the housing plug 362 and the sensor unit opening 307, by placing the grooves (optionally including O-rings) into the sensor unit opening 307. A seal between sensor unit opening 307 and the housing plug 362, can prevent water, dirt, and other particulates from entering the interior of the cylinder head 308. In some cases, the housing plug 362 can include a threaded surface (e.g., a number of threads) to facilitate a connection between the housing plug 362 and the sensor unit opening 307. In this implementation, the interior of the cylinder head 308 can include a corresponding threaded surface that below the sensor unit opening 307 to be coupled to the thread surface of the housing plug 362.

The exploded view 300 also shows the cylinder head 308 having a dielectric lens opening 310 (also referred to as a “lens cavity 310”), as an opening disposed through a thickness of the cylinder head 308. The opening 310 can also be referred to as a bore 310. For example, the cylinder head 308 can have an opening that is partially disposed through a front surface of the cylinder head 308 to form a bore. The opening of the bore 310 allows for the dielectric lens 303 to be inserted and dielectric lens 303 can be an example of dielectric lens 103 described in reference to FIGS. 1A and 1B above. The bore 310 can extend between a cavity (e.g., sensor unit opening 307) of the cylinder head 308 and the interior of the cylinder body along the longitudinal axis, e.g., axis 314 shown in FIG. 3. Axis 314 can be an example of the longitudinal center axis 128 described in reference to FIG. 1A above. FIG. 3 also shows an axis 316 substantially perpendicular to axis 314, in which axis 316 shows the sensor unit opening 307 extending vertically in the cylinder head 308.

Similar to dielectric lens 103 described in reference to FIGS. 1A and 1B, the dielectric lens 303 can be coupled to the sensor housing unit 306, to allow for propagation of beams between (e.g., to and from) the sensor unit 304 of the sensor housing unit 306 and the dielectric lens 303. The exploded view 300 also shows an O-ring 312 configured to form a seal between the dielectric lens 303 and the bore 310 of the cylinder head 308, e.g., to help stabilize the dielectric lens and reduce the effects of vibrations in signal data quality. The O-ring 312 also provides a seal between the sensor unit opening 307 (e.g., in addition to sensor housing unit 306) and the partial chamber 154.

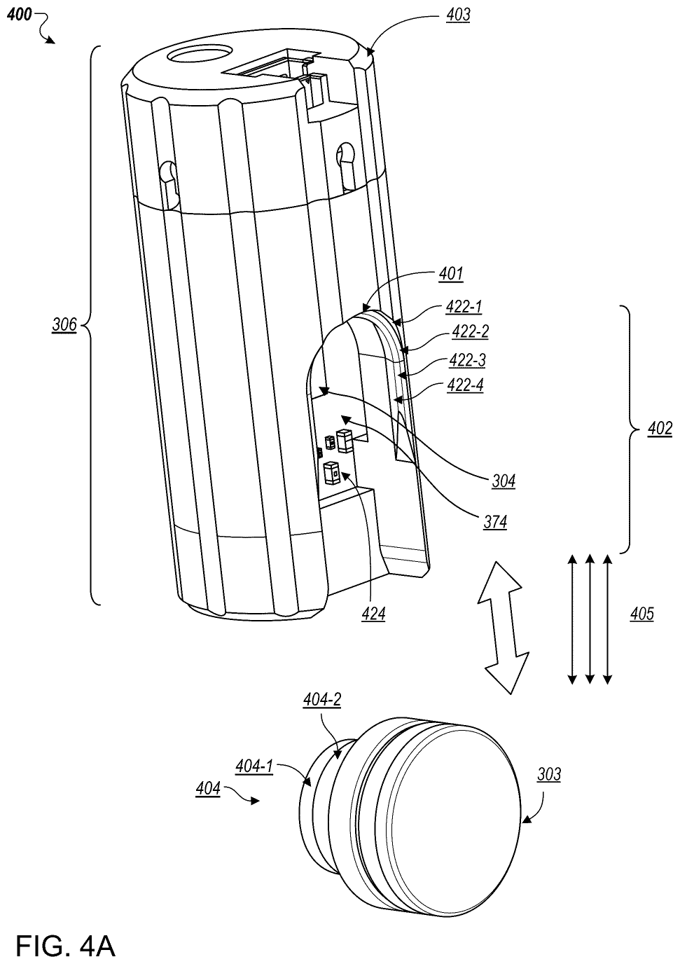

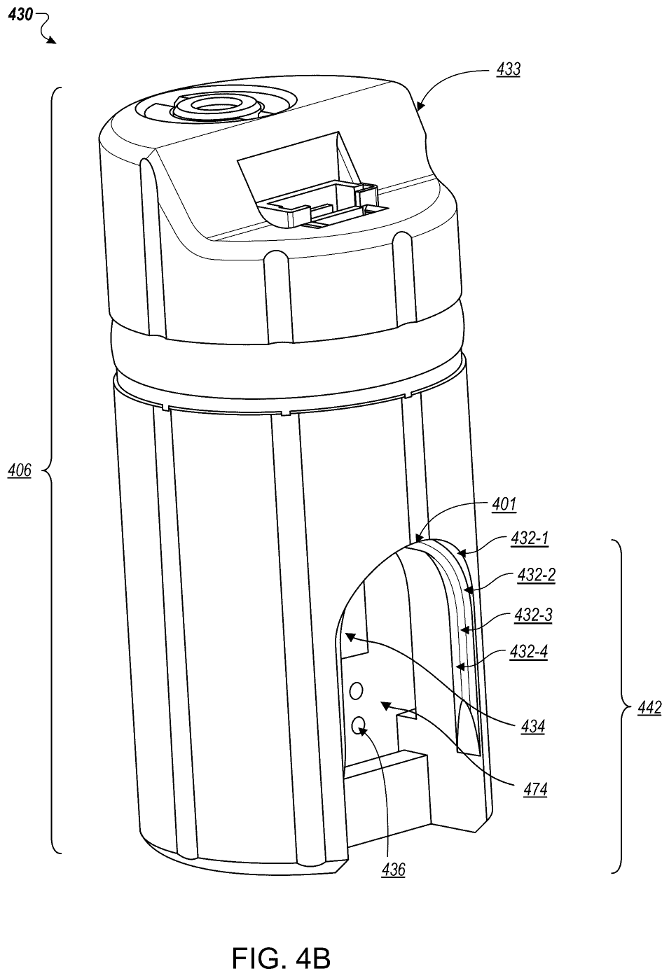

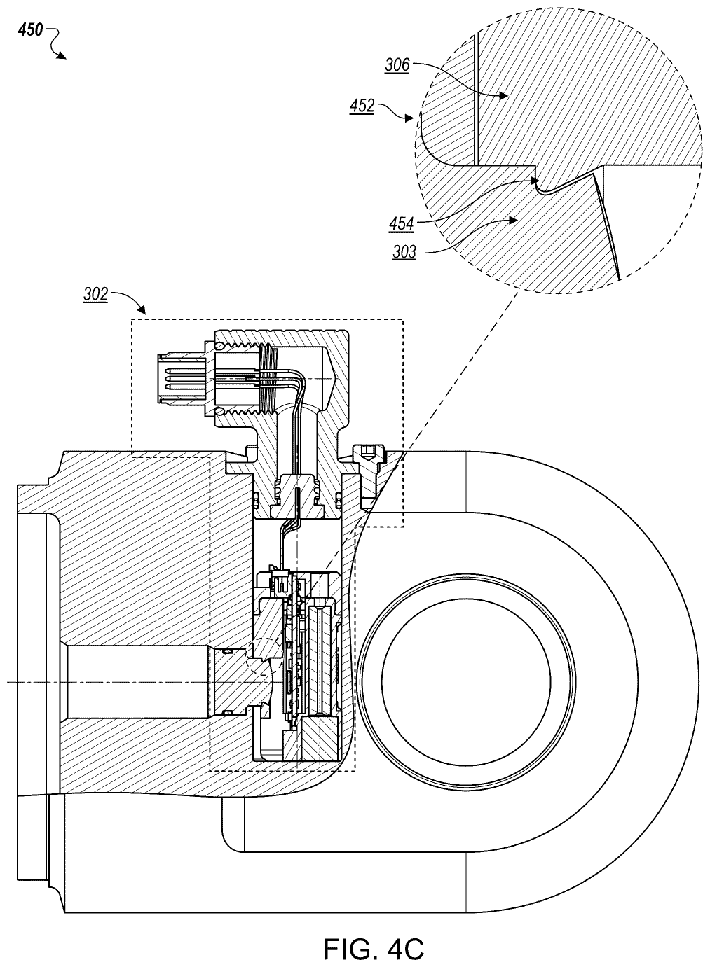

FIG. 4A is a close up view 400 of a sensor housing unit 306 and a dielectric lens 303 for the sensor assembly block (e.g., sensor assembly block 102 of FIGS. 1A and 1B, sensor assembly block 302 of FIG. 3). The view 400 shows the sensor housing unit 306 and the dielectric lens 303 each containing a shape that allows for the sensor housing unit 306 to receive the dielectric lens 303 by sliding the dielectric lens into an opening of the sensor housing unit 306. The dielectric lens 303 includes circumferential grooves 404, which are shown in FIG. 4A with a round shape. The sensor housing unit 306 includes an opening 402 with recesses that are configured to receive the circumferential grooves 404 of the dielectric lens 303. Each recess of the opening 402 of the sensor housing unit 306 can contain a shape that fits to the circumferential grooves 404 of the dielectric lens 303. For example, the recesses of the opening 402 of the sensor housing unit 306 can have a round shape that allows for the round shape of the circumferential grooves 404 to fit into the recesses of the opening 402. The dielectric lens 303 can be coupled to the sensor housing unit 306 by sliding the dielectric lens 303 into the opening 402 of the sensor housing unit 306, e.g., along a direction 405 shown in FIG. 4A. In this way, the circumferential grooves 404 of the dielectric lens 303 can slide into the recesses of the opening 402 of the sensor housing unit 306.

The view 400 also shows the sensor housing unit 306 having a removable cap 403 to cover a top portion of the sensor housing unit 306. The cap 403 depicted in FIG. 4A is illustrated as having a relatively flat shape. The cap can provide mechanical protection to the sensor housing unit 306 (e.g., including the internal components of the sensor housing unit 306), thereby improving impact resistance and structural support. The cap 403 can also prevent contaminants from entering ports, connectors, and other types of openings in the sensor housing unit 306, e.g., sealing the sensor housing unit 306 from dust, water, and/or debris.

The view 400 of the sensor housing unit 306 shows the opening 402 with a number of recesses 422-1 through 422-4 (collectively “recesses 422”) that can be coupled the circumferential grooves of the dielectric lens. The dielectric lens 303 can include a number of circumferential grooves, shown as circumferential grooves 404-1 and 404-2 (collectively “circumferential grooves 404”). The circumferential grooves 404-1 and 404-2 of the dielectric lens 303 can be slid into the recesses 422 of the opening 402 of the sensor housing unit 306. In some implementations, one or more recesses and/or one or more portions of the shape of a recess can include an additional mechanism to secure the grooves 404 into the recesses 422. In some cases, the mechanism can be formed from one or more recesses of the recesses 422 to hold the dielectric lens 303, e.g., by one or more grooves 404.

The clamping mechanism can allow for the insertion of dielectric lens 303 by sliding the lens into the sensor housing unit 306 such that the grooves 404 interact with the recesses 422. For example, the grooves 404 can initially connect to the recesses 422 of the opening 402, and at full insertion of the dielectric lens 303 into the opening 402, the dielectric lens 303 also engages with a top portion 401 of the opening 402. In this way, the dielectric lens 303 is secured and reduces the likelihood of the lens 303 moving (e.g., in or out of) the dielectric lens opening, e.g., dielectric lens opening 310 in reference to FIG. 3 above. Further, the insertion of the housing plug 362 into the sensor unit opening 307 can provide structural support to secure the sensor in place, e.g., to reduce noise from vibrations during operation of the hydraulic cylinder. FIG. 4A also shows the substrate 374 having electrical components 424, such as electrical contact pads or any type of electrical connections that can be used for components of the sensor unit 304.

FIG. 4B shows a front view 430 of the sensor housing unit 406 similar to the sensor housing unit 306 but with a different shape at the top portion of the sensor housing unit. The front view 430 shows a removable cap 433 to cover a top portion of the sensor housing unit 406. In contrast to the cap 403 403 depicted in FIG. 4A, the cap 433 is illustrated as having an “angle and step” shape, e.g., a flat portion, an angular portion, and then another flat portion. Similar to cap 403, the cap 433 can provide mechanical protection to the sensor housing unit 406 (e.g., including the internal components of the sensor housing unit 406), thereby improving impact resistance and structural support. The cap 433 can also prevent contaminants from entering ports, connectors, and other types of openings in the sensor housing unit 406, e.g., sealing the sensor housing unit 406 from dust, water, and/or debris.

The front view 430 shows the sensor housing unit 406 having an opening 442 with a number of recesses 432-1 through 432-4 (collectively “recesses 432”) that can be coupled the circumferential grooves of the dielectric lens. Similar to the example depicted in FIG. 4A, a dielectric lens 303 can include a number of circumferential grooves, shown as circumferential grooves 404-1 and 404-2 (collectively “circumferential grooves 404”). The circumferential grooves 404-1 and 404-2 of the dielectric lens 303 can be slid into the recesses 432 of the opening 402 of the sensor housing unit 406. In some implementations, one or more recesses and/or one or more portions of the shape of a recess can include an additional mechanism to secure the grooves 404 into the recesses 432. In some cases, the mechanism can be formed from one or more recesses of the recesses 432 to hold the dielectric lens 303, e.g., by one or more grooves 404.

The clamping mechanism can allow for the insertion of dielectric lens 303 by sliding the lens into the sensor housing unit 406 such that the grooves 404 interact with the recesses 432. For example, the grooves 404 can initially connect to the recesses 432 of the opening 402, and at full insertion of the dielectric lens 303 into the opening 402, the dielectric lens 303 also engages with a top portion 401 of the opening 402. In this way, the dielectric lens 303 is secured and reduces the likelihood of the lens 303 moving (e.g., in or out of) the dielectric lens opening, e.g., dielectric lens opening 310 in reference to FIG. 3 above. Further, the insertion of the housing plug 362 into the sensor unit opening 307 can provide structural support to secure the sensor in place, e.g., to reduce noise from vibrations during operation of the hydraulic cylinder. FIG. 4B also shows a substrate 474 (e.g., similar to substrate 374 of FIGS. 3 and 4A) having electrical contact pads 436, as an example of another type of electrical connections that can be used for components of the sensor unit 434, e.g., similar to sensor unit 104 of FIGS. 1A and 1B and sensor unit 304 of FIGS. 3 and 4A.

FIG. 4C is a close-up, cross-sectional view 450 (e.g., cross sectional view 450) of the sensor assembly block 302 of FIG. 3. The cross-section view 450 includes the close-up view 452 of a contact point between the sensor housing unit 306 and the dielectric lens 303. The contact point shows a clamping mechanism 454 formed from the sensor housing unit 306, thereby holding one or more circumferential grooves 404 (e.g., referring to FIG. 4A) of the dielectric lens 103 into the one or more recesses 432 (e.g., referring to FIG. 4A) of the sensor housing unit 306.

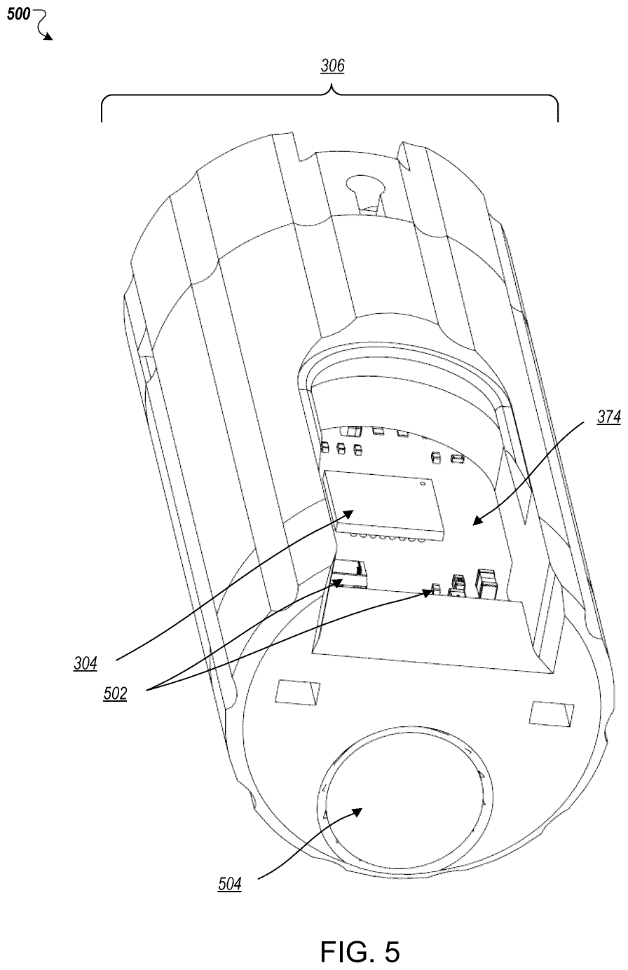

FIG. 5 shows a bottom view 500 of the sensor housing unit of FIGS. 3, and 4A through 4C. The bottom view 500 shows the sensor unit 304 of the sensor housing unit 306 as a system-on-a-chip, mounted onto the substrate 374 and enclosed by the sensor housing unit 306. The substrate 374 can include additional power stage components mounted and/or embedded into the substrate 374. For example, the substrate 374 shows power component stage components 502 mounted onto a surface of the substrate. Examples of power stage components 502 include amplifiers, current/voltage regulators and converters, etc.

A magnet 504 located at a bottom surface of the sensor housing unit 306 can provide an additional mechanism to position the sensor housing unit 306 (including its components, e.g., sensor unit 304) to the bottom of the sensor unit opening, e.g., sensor unit opening 307 in reference to FIG. 3 above. In some cases, both the housing plug 362 (e.g., as described in reference to FIG. 3 above) and the magnet 504 can be used to retain the sensor in its position to reduce the effects of vibration on the dielectric lens, the sensor unit 304, and related components, e.g., retaining the sensor housing unit 306 in the base of the sensor unit opening 307.

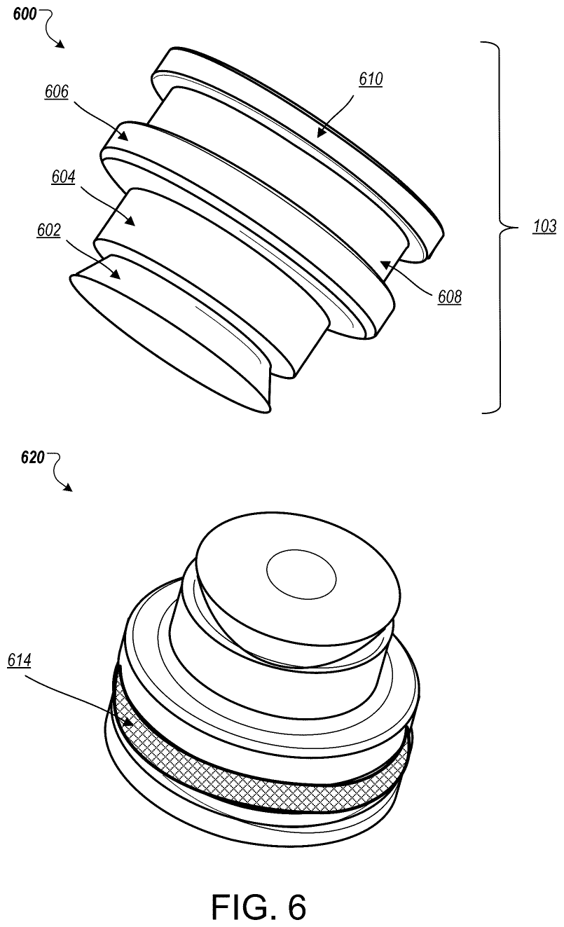

FIG. 6 shows example views 600 and 620 of the dielectric lens 103. For example, the view 600 shows the dielectric lens 103 having a first surface 602, a second surface 604, a first protrusion 606, a groove 608, and a second protrusion 610. The first surface 602 and the second surface 604 can have a shape that defines the shape of clamping mechanism 454, as described in reference to FIG. 4A through 4C above. Although two surfaces (e.g., surface 602 and 604) are illustrated in FIG. 6, the dielectric lens 103 can include a number of surfaces, each having a shape to facilitate insertion of the dielectric lens 103 into the opening of a sensor unit. For example, the first surface 602 can have a sloped shape that facilitates the insertion of the dielectric lens 103 into the opening of the sensor housing unit, e.g., opening 402 of the sensor housing unit 306, and holds the dielectric lens 103 in place. As illustrated, the first surface 602 has a flared shape that allows for the dielectric lens 103 to be slidably connected into the opening, which has a corresponding shape to receive the flared shapes. The dielectric lens 103 also includes the first protrusion 606 (illustrated in FIG. 6 on a first side of the groove 608) and the second protrusion 610 (illustrated in FIG. 6 on a second side of the groove 608, the second side opposite the first side). The protrusions 606 and 610 can be configured to align to the dielectric lens opening 310, e.g., engaging with the lens opening 310 when the dielectric lens 103 is inserted into the cylinder head 308.

The view 620 of the dielectric lens 103 shows an O-ring 614 (illustrated with a cross-hatched pattern) placed over the groove 608 of the dielectric lens 103.

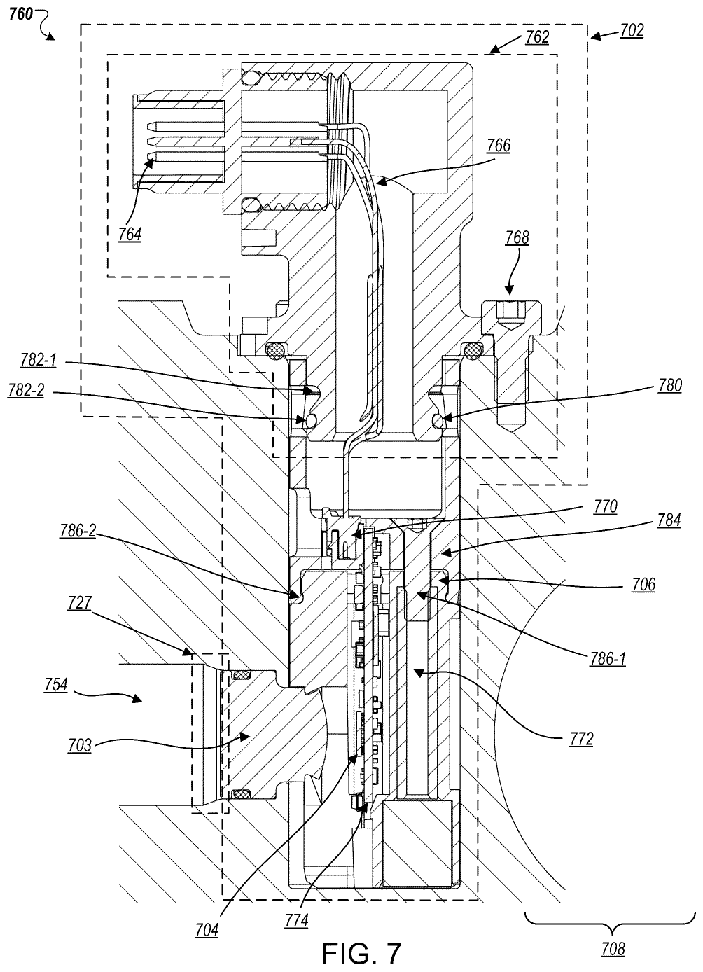

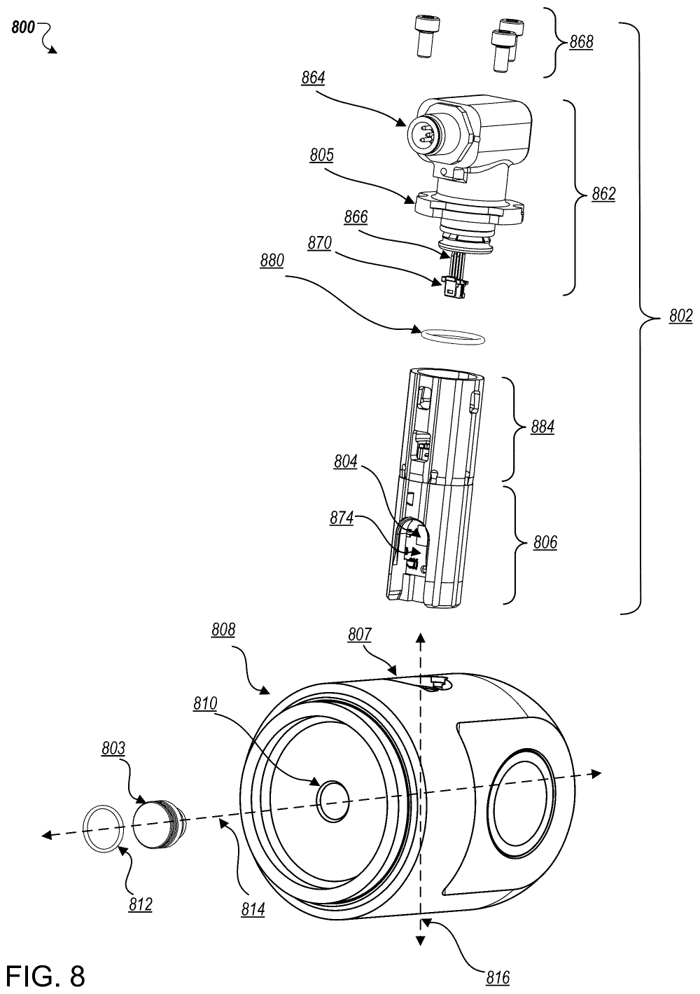

FIG. 7 is a cross-sectional view 760 of a sensor assembly block 702 (also referred to as a “sensor block 702”) of a hydraulic cylinder (e.g., cylinder 101) similar to the sensor block 102 of FIG. 1A. The sensor block 702 is arranged in a cavity of the hydraulic cylinder, e.g., similar to cavity 105 of FIG. 1A, and includes a cylinder sensor unit 704. The sensor unit 704 can be used to detect the position of a piston and/or the piston rod, e.g., piston 112 and/or the piston rod 120 of FIG. 1A, along a length of a cylinder body of a hydraulic cylinder using high-frequency electromagnetic waves (e.g., using radar signals). As described in reference to FIG. 8 below, the sensor block 702 can include a housing for the sensor unit 704, e.g., to secure the sensor unit 704 in a cavity of the hydraulic cylinder.

Similar to the sensor unit 104 of FIGS. 1A and 1B, the sensor unit 704 can be a radar sensing unit that includes radar sensors and/or emitters to emit radar signals into the cylinder body and detect reflected radar signals. Movement of the piston can be determined based on the reflected signal using high-frequency technology, such as evaluating the transit time of radar signals reflected back to the sensor. Similar to the hydraulic cylinder described in reference to FIG. 1B, the reflected signals can be used to determine the current position of a piston along the longitudinal axis of the hydraulic cylinder, e.g., at a single time instance, periodically, continuously, or at specific points in time.

The sensor block 702 can include a sensor housing 706 that includes the sensor unit 704 coupled to a dielectric lens 703. The sensor block 702 can be positioned in a cavity of the hydraulic cylinder to form a seal that prevents hydraulic fluid from escaping, e.g., from a partial chamber 754 of the hydraulic cylinder into the sensor unit 704. The seal can be formed between the partial chamber 754 and the dielectric lens 703, and between the dielectric lens 703 and the sensor housing 706. The partial chamber 754 also includes an axially extending sensor signal channel 727, e.g., similar to partial chamber 154 shown in FIG. 1A.

The dielectric lens 703 is shaped and positioned so as to direct high-frequency signals toward the sensor unit 704, similar to the dielectric lens 103 described above in reference to FIGS. 1A and 1B. The dielectric lens 703 can be configured (e.g., based on the material and/or shape) to serve as a filter that focuses on a target range of beams, such as high-frequency beams or substantially high-frequency beams for the sensor unit.

FIG. 7 also illustrates a housing connector 770 for carrying electrical signals through wires 766. The housing connector 770 can be a pico-clasp plug that connects a housing plug 762 to the sensor unit 704, e.g., by mounting the sensor unit 704 onto a substrate 774 and coupling the housing connector 770 to the substrate 774. For example, the substrate 774 can include one or more ports configured to receive the housing connector 770. Similar to the substrate 174 of FIGS. 1A and 1B, the substrate 774 can include one or more electrical components mounted on a surface of the substrate 774, embedded in the substrate 774, etc.

The sensor block 702 can include the housing plug 762 with a number of components that facilitate connections to and from a device for providing control to the hydraulic cylinder, e.g., a computing device, e.g., through a connector plug 764 to transmit and receive signals between a computing and the sensor unit 704. The sensor block 702 can include a housing connector 770 that attaches to the sensor unit 704 (e.g., through the housing connector 770 coupled to the substrate 774, where the sensor unit 704 is mounted). In some cases, the housing connector 770 can be coupled to the sensor unit 704, prior to the insertion of the sensor unit 704 into the cavity 105. In some implementations, the connector plug 764 is an M12 connector, although any other type of hydraulic cylinder connector configured to carry to provide signals may be utilized.

Similar to the housing plug 162, the housing plug 762 includes a number of pins for communication to and from the sensor unit 704 and other devices. The sensor block 702 can include one or more fixing screws 768 to affix the housing plug 762 to a cylinder head, e.g., cylinder head 108 of FIGS. 1A and 1B. Although FIG. 7 depicts a close-up view of the sensor block 702 with the cylinder head 708, the cylinder head 708 can be an example of a cylinder head 108 described in reference to FIGS. 1A and 1B above or the cylinder head 808 described in reference to FIG. 8 below. The sensor block 702 also includes a threaded pipe 772 which can be used to align the position of the sensor housing 704 in a cavity of the hydraulic cylinder.

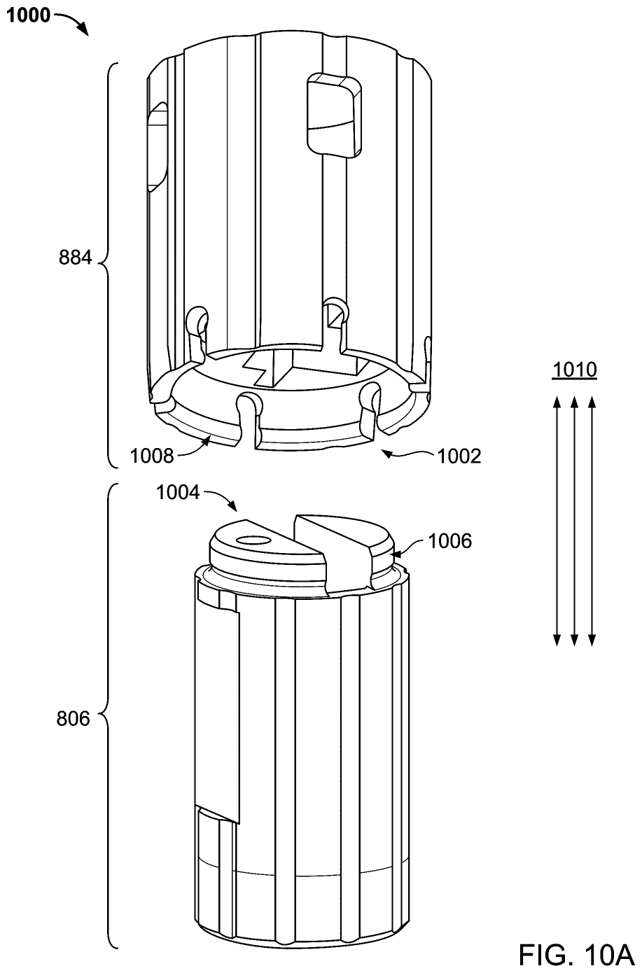

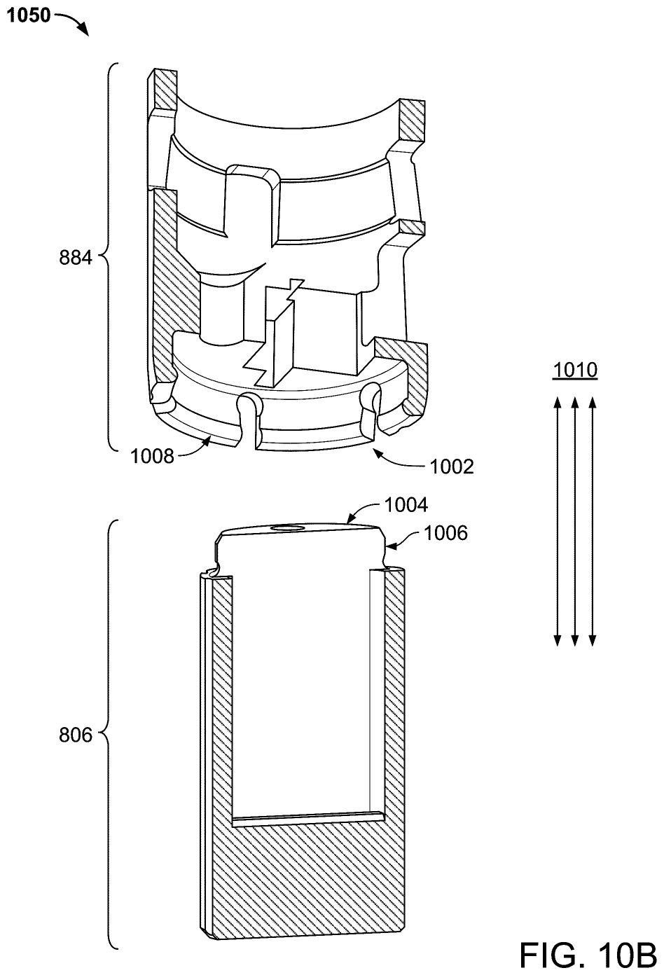

The sensor block 702 can include an interconnection spacer 784 that couples the sensor housing 706 to the housing plug 762. As described in reference to FIGS. 10A and 10B below, the interconnection spacer 784 (“also referred to as spacer 784”) can include a top portion to couple to the housing plug 762 and a bottom portion to couple to the sensor housing 706. Referring to a bottom portion of spacer 784, the spacer 784 attaches to the sensor housing 706 by attachment mechanisms 786-1 and 786-2, which can be a latch, screw, or another type of mechanical attachment. For example, the attachment mechanism 786-1 can be a latch and the attachment mechanism 786-2 can be a screw. In some implementations, the attachment mechanism 786-2 can include one or more snap features to connect the spacer 784 to the sensor housing 706.

The attachment mechanisms 786-1 and 786-2 can be configured to couple the spacer 784 to the sensor housing 706. At a top portion of the spacer 784, the spacer 784 can be retained by the housing plug 762 by a retaining mechanism 780, such an o-ring or another type of mechanical gasket. By coupling the sensor housing 706 to the housing plug 762 by the spacer 784, the sensor block 702 can be an assembly of three components that are mechanically connected to each other, e.g., to form a single complete assembly that provides improved rigidity for the sensor block 702 compared to sensor block 102 of FIGS. 1A and 1B. For example, the sensor block 102 can include a wire assembly (e.g., wires 166) without a structural support between the housing plug 762 and the sensor housing 106. The spacer 784 can be a mechanical component that maintains a distance between two or more objects in the assembly.

The sensor block 702 with the spacer 784 provides improved mechanical rigidity and stability relative to the sensor block 302. The spacer 784 can provide a mechanical interface between the sensor housing 706 and the housing plug 762, to mechanically secure the sensor housing 706 to the housing plug 762. The spacer 784 can provide improved robustness, by reducing or preventing pull stress on the interconnection wires 766, as the housing plug 762 is mechanically fixed to the sensor housing 706 by the spacer 784. The spacer 784 can also provide improved efficiency during assembly and disassembly, as the entire cartridge (e.g., sensor housing 706, spacer 784, and housing plug 762) can be connected as a single assembly. A single assembly provides easier installation compared to installation of a separated sensor housing 706 and housing plug 762. A single assembly also improves reliability and durability through the improved rigidity, e.g., to mitigate vibrational fluctuations experienced by the hydraulic cylinder during operation.

Referring to the retaining mechanism 780, the housing plug 762 includes an upper slot 782-1 and a lower slot 782-2 (collectively “slots 782”) for positioning the retaining mechanism 780. Examples of slots can include grooves or recesses where the retaining mechanism 780 can be placed. For example, the retaining mechanism 780 in upper slot 782-1 provides assembly of the spacer 784 to the housing plug 762, e.g., inserting a top portion of the spacer 784 to a bottom portion of the housing plug762. In the lower slot 782-2, the retaining mechanism 780 can be configured to retain the spacer 784 to the housing plug 762. While in the lower slot 782-2, the retaining mechanism 780 can securely retain the spacer 784 to the housing plug 762, e.g., to allow for insertion or engagement in the upper slot 782-1 and to interlock to prevent removability of the spacer 784 in the lower slot 782-2. In the lower slot 782-2, the spacer 784 can allow for the sensor block 702 to be rotated, e.g., to orient the connector plug 764, while retaining the spacer 784 in the sensor housing 706 . . . . Although FIG. 7 depicts a pair of slots, the spacer 784 can include any number of slots.

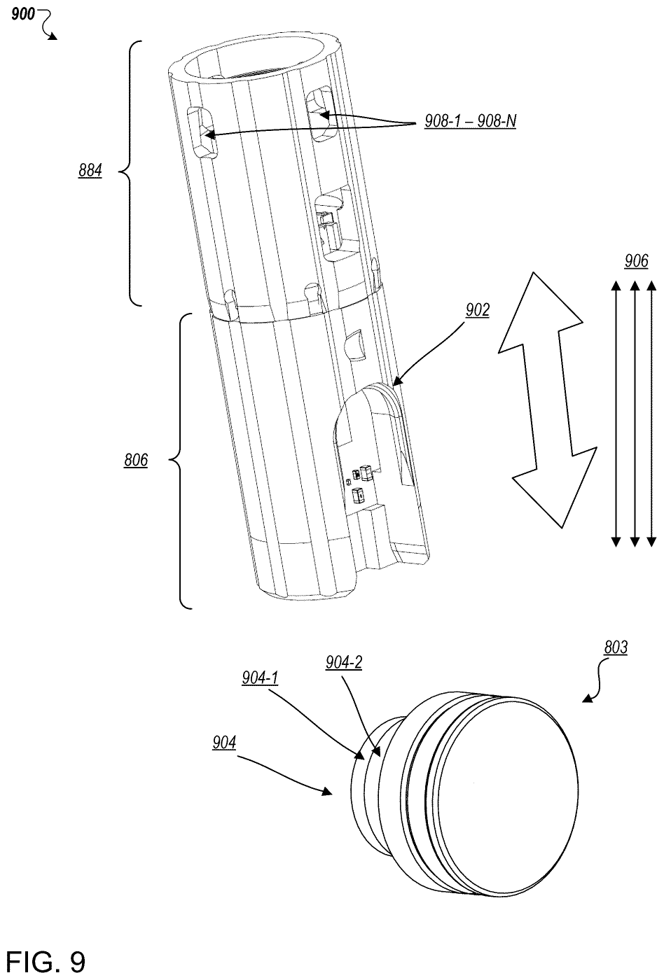

A spacer 784 can be any length and the length of the spacer can be based on a diameter of the hydraulic cylinder. In some implementations, the length of a spacer 784 can be approximately 3 inches. The spacer 784 can also be a longer length for a hydraulic cylinder with a relatively large diameter, or a shorter length for a hydraulic cylinder with a relatively small diameter. The retaining mechanism 780 can be adjusted from one slot to another, e.g., slot 782-1 to 782-2 or vice versa, using a tool to mechanically adjust the position by pulling the retaining mechanism 780. As described in reference to FIG. 9 below, the spacer 784 includes one or more openings that allow for adjustment of the retaining mechanism 780.

FIG. 8 is an exploded view 800 of the sensor assembly block 802 (also referred to as “sensor block 802”), which is an example of the sensor block 702 of FIG. 7. The exploded view 800 depicts the sensor block 802 with a cylinder head 808 that is a different shape and design than the cylinder head 108 depicted in FIGS. 1A and 1B. The exploded view 800 shows the sensor block 802 having housing plug 862, which can be affixed to cylinder head 808 by one or more fixing screws 868, e.g., similar to fixing screws 168 described in reference to FIG. 1B above. For example, the housing plug 862 can include a plate 805 with a number of openings disposed through a thickness of the plate 805. Similar to plate 305, the plate 805 can be formed from the same body of the housing plug 862 but can also be an additional component attached to the housing plug 862. Each fixing screw 868 can be disposed in an opening of the plate 805 to secure the housing plug 862 to the cylinder head 808, e.g., by placing the fixing screw 868 into an opening disposed in a surface of the cylinder head 808.

The cylinder head 808 also includes a sensor unit opening 807 (also referred to as a “sensor unit cavity 807”), which is an opening that extends through a wall of the cylinder head 808, e.g., to form a cavity, to allow for insertion of a sensor housing unit 806 (e.g., an example of sensor housing unit 106 of FIGS. 1A and 1B). The sensor housing unit 806 depicted in FIG. 8 can be similar to the sensor housing 306 described in reference to FIG. 4A, but without a cap covering a top portion of the sensor housing unit 806. An example illustration of the sensor housing unit 806 without a cap is depicted and described in reference to FIG. 10A below. The sensor housing unit 806 can include a sensor unit 804, similar to sensor unit 104 as described in reference to FIGS. 1A and 1B above. The sensor unit 804 is mounted on a substrate 874, e.g., an example of a substrate 174 (such as a printed circuit board) described in reference to FIG. 1B above. The sensor housing unit 806 can be coupled to the housing plug 862 by the housing connector 870, e.g., similar to housing connector 170 of FIG. 1B.

A housing connector 870 can be configured to attach the sensor housing unit 806 to the housing plug 862 by wires configured to communicate signals between the sensor unit 804 and a data port of the housing plug 862, e.g., to provide signals to a computing device, machine, or some combination thereof, coupled to the hydraulic cylinder. The sensor housing unit 806 includes a sensor unit 804, similar to the sensor unit 104 described in reference to FIGS. 1A and 1B above but can also be an example sensor unit 202 described in reference to FIGS. 2A and 2B above. The housing connector 870 can be used to couple the sensor housing unit 806 to the housing plug 862 prior to the insertion of the sensor housing unit 806 into a cavity of the cylinder head 808.

As illustrated in FIG. 8, the housing plug 862 can include a number of grooves and/or corresponding O-rings to form a seal between the housing plug 862 and the sensor unit opening 807, by placing the grooves (optionally including O-rings) into the sensor unit opening 807. A seal between sensor unit opening 807 and the housing plug 862, can prevent water, dirt, and other particulates from entering the interior of the cylinder head 808. In some cases, the housing plug 862 can include a threaded surface (e.g., a number of threads) to facilitate a connection between the housing plug 862 and the sensor unit opening 807. In this implementation, the interior of the cylinder head 808 can include a corresponding threaded surface that below the sensor unit opening 807 to be coupled to the thread surface of the housing plug 862.

Similar to the sensor block 702 described above in reference FIG. 7, the exploded view 800 depicts the sensor block 802 having an interconnection spacer 884 that couples the sensor housing 806 to the housing plug 862, e.g., similar to spacer 784 described in reference to FIG. 7. The interconnection spacer 884 (“also referred to as spacer 884”) can include a top portion to couple to the housing plug 862 and a bottom portion to couple to the sensor housing 806. Referring to a bottom portion of spacer 884, the spacer 884 attaches to the sensor housing 806 by attachment mechanisms, e.g., a latch, screw, snap feature, or another type of mechanical attachment.

At a top portion of the spacer 884, the spacer 884 can be retained by the housing plug 862 by a retaining mechanism 880, such an O-ring or another type of mechanical gasket. By coupling the sensor housing 806 to the housing plug 862 by the spacer 884, the sensor block 802 can be an assembly of three components that are mechanically connected to each other, e.g., to form a single complete assembly that provides improved rigidity, durability, and easy of assembly/disassembly.

Similar to sensor block 702 described in reference to FIG. 7, the sensor block 802 As described in reference to FIG. 7, the spacer 884 of the sensor block 802 provides a mechanical interface between the sensor housing 806 and the housing plug 862, to mechanically secure the sensor housing 806 to the housing plug 862. The spacer 884 can provide improved robustness, by reducing or preventing pull stress on the interconnection wires 866, as the housing plug 862 is mechanically fixed to the sensor housing 806 by the spacer 884. The spacer 884 can also provide improved efficiency during assembly and disassembly, as the entire cartridge (e.g., sensor housing 806, spacer 884, and housing plug 862) can be connected as a single assembly.

The retaining mechanism 880 can also be positioned inside of the spacer 884, e.g., such as a slot of the housing plug 862, to retain the spacer 884 to the housing plug 862 to allow for interlocking that prevents removal of the spacer 884 from the housing plug 862. The spacer 884 can allow for the sensor block 802 to be rotated, e.g., to orient the connector plug 864, e.g., an example of a connector plug such as connector plug 164 of FIG. 1B, while retaining the spacer 884 in the sensor housing 806. For example, the retaining mechanism 880 can be inserted into the spacer 884.

The exploded view 800 also shows the cylinder head 808 having a dielectric lens opening 810 (also referred to as a “lens cavity 810”), as an opening disposed through a thickness of the cylinder head 808. The opening 810 can also be referred to as a bore 810. For example, the cylinder head 808 can have an opening that is partially disposed through a front surface of the cylinder head 808 to form a bore. The opening of the bore 810 allows for the dielectric lens 803 to be inserted and dielectric lens 803 can be an example of dielectric lens 103 described in reference to FIGS. 1A and 1B above. The bore 810 can extend between a cavity (e.g., sensor unit opening 807) of the cylinder head 808 and the interior of the cylinder body along the longitudinal axis, e.g., axis 814 shown in FIG. 8. Axis 814 can be an example of the longitudinal center axis 128 described in reference to FIG. 1A above. FIG. 8 also shows an axis 816 substantially perpendicular to axis 814, in which axis 816 shows the sensor unit opening 807 extending vertically in the cylinder head 808. The sensor block 802, including the sensor housing unit 806 coupled to the spacer 884 (further couples to the housing plug 862) the can be inserted into the cavity 807.

Similar to dielectric lens 103 described in reference to FIGS. 1A and 1B, the dielectric lens 803 can be coupled to the sensor housing unit 806, to allow for propagation of beams between (e.g., to and from) the sensor unit 804 of the sensor housing unit 806 and the dielectric lens 803. The exploded view 800 also shows an O-ring 812 configured to form a seal between the dielectric lens 803 and the bore 810 of the cylinder head 808, e.g., to help stabilize the dielectric lens and reduce the effects of vibrations in signal data quality. The O-ring 812 also provides a seal between the sensor unit opening 807 (e.g., in addition to sensor housing unit 806) and a partial chamber of the hydraulic cylinder, e.g., partial chamber 154 shown in FIG. 1A.

FIG. 9 is a close up view 900 of a sensor housing unit, spacer, and a dielectric lens for the sensor assembly block of FIGS. 7 and 8. The close up view 900 shows the sensor housing unit 806 coupled to the spacer 884, with the dielectric lens 803 for the sensor assembly block (e.g., sensor assembly block 702 of FIG. 7 and assembly block 802 of FIG. 8). The view 900 shows the sensor housing unit 806 and the dielectric lens 803 each containing a shape that allows for the sensor housing unit 806 to receive the dielectric lens 803 by sliding the dielectric lens into an opening of the sensor housing unit 806. The dielectric lens 803 includes circumferential grooves 904, which are shown in FIG. 9 with a round shape. The sensor housing unit 806 includes an opening 902 with recesses that are configured to receive the circumferential grooves 904 of the dielectric lens 303. Each recess of the opening 902 of the sensor housing unit 806 can contain a shape that fits to the circumferential grooves 904 of the dielectric lens 303. For example, the recesses of the opening 902 of the sensor housing unit 806 can have a round shape that allows for the round shape of the circumferential grooves 904 to fit into the recesses of the opening 902. The dielectric lens 803 can be coupled to the sensor housing unit 806 by sliding the dielectric lens 803 into the opening 902 of the sensor housing unit 806, e.g., along a direction 906 shown in FIG. 9. In this way, the circumferential grooves 904 of the dielectric lens 803 can slide into the recesses of the opening 902 of the sensor housing unit 806.

The view 900 also depicts the spacer 884 having one or more openings 908-1 through 908-N (collectively “openings 908”). As described in reference to FIG. 7 above, a spacer, e.g., spacer 884, can include openings 908 to allow for adjustments to a retaining mechanism 880, e.g., to adjust the position of the retaining mechanism 880 from one slot to another slot, such as grooves of an internal portion of the spacer 884. The retaining mechanism 880 can be adjusted from one slot to another slot using a tool to mechanically adjust the position of the retaining mechanism 880, e.g., by pulling the retaining mechanism 880 upward or downward between two different slots or grooves.

FIG. 10A shows a close-up view of the spacer 884 and a top view of sensor housing unit 806, of FIGS. 7, 8, and 9. The close-up view 1000 depicts the spacer 884 having a bottom portion 1002 and the sensor housing unit 806 having a top portion 1004. The top portion 1004 of the sensor housing unit 806 can include one or more protrusions 1006, such as a groove, notch, or ridge. The top portion 1004 can be an example of a sensor housing unit without a cap, such as cap 403 described in reference to FIG. 4A above. The top portion 1004 of the sensor housing unit 806 can be inserted into the bottom portion 1002, e.g., to couple the sensor housing unit 806 to the spacer 884. In some implementations, the protrusions 1006 of the sensor housing unit 806 can be inserted into the bottom portion 1002 of the spacer 884, such as in a vertical direction 1010 to retain the sensor housing unit 806 in the spacer 884. For example, the top portion 1004 of the sensor housing unit 806 can be inserted into the bottom portion 1002 of the spacer 884 by moving the sensor housing 806 upward and into the bottom portion 1002. As another example, the bottom portion 1002 of the spacer 884 can be placed over and moving downward onto the top portion 1004 of the sensor housing unit 806. In some implementations, the top portion 1004 of the sensor housing 806 can be placed over and move into the bottom portion 1002 of the spacer 884.

The spacer 884 can include a number of attachment mechanisms 1008, e.g., latches, configured to engage with the protrusions 1006, e.g., to retain the sensor housing unit 806. The attachment mechanisms 1008 can be an example of attachment mechanisms 786-1 and 786-2, as described in reference to FIG. 7 above. Examples of latches can include snap-fit latches and sliding latches. For example, a latch can be configured to temporarily bend, e.g., while connected the spacer 884 to the sensor housing unit 806, and snap into a locking position. The attachment mechanisms 1008 can include screws to retain the sensor housing unit 806, e.g., by the protrusions 1006 of the sensor housing unit 806.

FIG. 10B shows a cross-sectional view of the spacer and the sensor housing unit of FIG. 10A. The cross-sectional view 1050 shows the bottom portion 1002 of the spacer 884 and the top portion 1004 of the sensor housing unit 806. Similar to FIG. 10A above, the top portion 1004 can include protrusions 1006 of the sensor housing unit 806 can be inserted into the bottom portion 1002 of the spacer 884, e.g., to couple the sensor housing unit 806 to the spacer 884. Similarly, the protrusions 1006 of the sensor housing unit 806 can be inserted into the bottom portion 1002 of the spacer 884 or vice versa, as depicted by a vertical direction 1010. The spacer 884 includes attachment mechanisms 1008 configured to engage with the protrusions 1006, e.g., to retain the sensor housing unit 806 by the spacer 884.

While this specification contains many specific implementation details, these should not be construed as limitations on the scope of the technology described in this specification or on the scope of what may be claimed, but rather as descriptions of features that may be specific to particular embodiments of the disclosed technology. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

Some of the examples described herein include or are defined by the following implementations.

Implementation A1 is a hydraulic cylinder assembly comprising: a cylinder body; a piston configured to slide within an interior of the cylinder body; a cylinder head coupled to a first end of the cylinder body, the cylinder head comprising a cavity and a bore that extends between the cavity and the interior of the cylinder body along a longitudinal axis; a radar sensing unit disposed within the cavity of the cylinder head, the radar sensing unit comprising a radar signal emitter and a radar signal detector oriented respectively to emit radar signals through the bore into the interior of the cylinder body and to detect reflected radar signals from the interior of the cylinder body indicative of a position of the piston; and a dielectric lens between the radar sensing unit and the interior of the cylinder body, the dielectric lens having a convex side facing the radar sensing unit and a planar side opposite the convex side facing the interior of the cylinder body.

Implementation A2 is the hydraulic cylinder assembly of A1, wherein the bore that extends between the cavity and the interior of the cylinder body along the longitudinal axis is an axial bore for insertion of the dielectric lens, and wherein the cavity is a radial bore for insertion of the radar sensing unit.

Implementation A3 is the hydraulic cylinder assembly of any of implementations A1-A2, wherein the convex side of the dielectric lens is adjacent to a first medium characterized by a first dielectric constant and the planar side of the dielectric lens is adjacent to a second medium characterized by a second dielectric constant.

Implementation A4 is the hydraulic cylinder assembly of any of implementations A1-A3, wherein the first medium is air and the second medium is a hydraulic fluid.

Implementation A5 is the hydraulic cylinder assembly of any of implementations A1-A4, wherein the radar sensing unit comprises one or more radar sensors configured to transmit and receive radio frequency (RF) signals.

Implementation A6 is the hydraulic cylinder assembly of any of implementations A1-A5, wherein the dielectric lens comprises polyether ether ketone (PEEK) material.

Implementation A7 is the hydraulic cylinder assembly of any of implementations A1-A6, wherein the radar signal emitter is configured to emit a transmit beam along a transmit beam path between the radar signal emitter and the dielectric lens, wherein the transmit beam enters the dielectric lens at a first incident angle at the convex side of the dielectric lens and the dielectric lens causes the transmit beam to refract at a second incident angle, the second incident angle allowing the transmit beam to exit the dielectric lens along an axis substantially parallel to a longitudinal center axis of the dielectric lens.

Implementation A8 is the hydraulic cylinder assembly of any of implementations A1-A7, wherein the dielectric lens is configured to refract a receive beam along a receive beam path between the cylinder body and the dielectric lens, wherein the receive beam enters the dielectric lens at a third incident angle at the planar side of the dielectric lens, and the dielectric lens causes the receive beam to refract at a fourth incident angle, the third incident angle being substantially perpendicular to the planar side of the dielectric lens, and the fourth incident angle allowing the receive beam to exit the dielectric lens at an angle to be received by the radar signal detector.

Implementation A9 is the hydraulic cylinder assembly of any of implementations A1-A8, wherein the radar sensing unit further comprises a sensor housing that encloses the radar sensing unit and wherein the sensor housing comprises an opening to receive the dielectric lens by inserting the dielectric lens into the bore that extends between the cavity and the interior of the cylinder body along the longitudinal axis.

Implementation A10 is the hydraulic cylinder assembly of any of implementations A1-A9, the sensor housing further comprising one or more recesses, and the dielectric lens further comprising one or more circumferential grooves, each recess from the one or more recesses of the sensor housing containing a shape that fits to the one or more circumferential grooves of the dielectric lens.

Implementation A11 is the hydraulic cylinder assembly of any of implementations A1-A10, wherein the dielectric lens is configured to be inserted into the sensor housing by sliding the one or more circumferential grooves of the dielectric lens into the one or more recesses of the sensor housing.

Implementation A12 is the hydraulic cylinder assembly of any of implementations A1-A11, wherein the sensor housing comprises one or more clamping mechanisms configured to hold the one or more circumferential grooves of the dielectric lens into the one or more recesses of the sensor housing.

Implementation A13 is the hydraulic cylinder assembly of any of implementations A1-A12, further comprising a spacer comprising a first end and a second end opposite the first end, the spacer coupled to the cylinder head at the first end and coupled to the sensor housing at the second end, wherein the sensor housing encloses the radar sensing unit.

Implementation A14 is the hydraulic cylinder assembly of any of implementations A1-A13, further comprising a gasket that aids in securing the spacer to the cylinder head.

Implementation A15 is the hydraulic cylinder assembly of any of implementations A1-A14, wherein the gasket is an O-ring.

Implementation A16 is the hydraulic cylinder assembly of any of implementations A1-A15, wherein the spacer comprises a cylindrical internal portion comprising at least two grooves, wherein each of the at least two grooves is configured to receive the O-ring, wherein the O-ring is configured to form a face seal between a first groove from the at least two grooves and an inner surface of the spacer when the O-ring is disposed onto the first groove, wherein the O-ring is configured to allow rotation of the cylinder head when the O-ring is disposed onto a second groove from the at least two grooves, and wherein the second groove is different than the first groove.

Implementation A17 is the hydraulic cylinder assembly of any of implementations A1-A16, wherein the spacer comprises one or more openings disposed through a thickness of the spacer, each of the one or more openings being located at a position on an outer surface of the spacer to provide access to the at least two grooves.

Implementation A18 is the hydraulic cylinder assembly of any of implementations A1-A17, wherein the spacer comprises a connector configured to electrically couple the radar sensing unit to a housing connector of the cylinder head.

Implementation B1 is a hydraulic cylinder assembly comprising: a cylinder body; a piston configured to slide within an interior of the cylinder body; a cylinder head coupled to a first end of the cylinder body, the cylinder head comprising a cavity and a bore that extends between the cavity and the interior of the cylinder body along a longitudinal axis; a radar sensing unit disposed within the cavity of the cylinder head, the radar sensing unit comprising a radar signal emitter and a radar signal detector oriented respectively to emit radar signals through the bore into the interior of the cylinder body and to detect reflected radar signals from the interior of the cylinder body indicative of a position of the piston; a removable dielectric lens between the radar sensing unit and the interior of the cylinder body, wherein the removable dielectric lens comprises one or more circumferential grooves; and a removable sensor housing containing the radar sensing unit and having one or more recesses, each recess from the one or more recesses of the removable sensor housing containing a shape that fits to the one or more circumferential grooves of the removable dielectric lens, wherein the one or more recesses are configured to slidably connect with the one or more circumferential grooves of the removable dielectric lens, wherein the removable sensor housing can repeatedly position the radar sensing unit a particular distance from the removable dielectric lens.

Implementation B2 is the hydraulic cylinder assembly of B1, wherein the removable sensor housing comprises an opening to receive the removable dielectric lens.

Implementation B3 is the hydraulic cylinder assembly of any of implementations B1-B2, wherein the removable dielectric lens is configured to be slidably connected to the removable sensor housing, by placing the one or more circumferential grooves of the removable dielectric lens into the one or more recesses of the removable sensor housing and sliding the one or more circumferential grooves of the removable dielectric lens into the one or more recesses of the removable sensor housing.

Implementation B4 is the hydraulic cylinder assembly of any of implementations B1-B3, wherein the removable sensor housing comprises one or more clamping mechanisms configured to hold the one or more circumferential grooves of the removable dielectric lens into the one or more recesses of the removable sensor housing.

Implementation C1 is a radar assembly for a hydraulic cylinder comprising a housing; a radar signal emitter disposed within the housing and configured to emit radar signals toward an interior of a hydraulic cylinder body when the radar assembly is installed in a hydraulic cylinder head of the hydraulic cylinder; a radar signal detector disposed within the housing and configured to detect reflected radar signals from the interior of the hydraulic cylinder body when the radar assembly is installed in the hydraulic cylinder head of the hydraulic cylinder; and a dielectric lens having (i) a convex side that faces the radar signal emitter and the radar signal detector when the radar assembly is installed in the hydraulic cylinder head and (ii) a planar side that faces the interior of the hydraulic cylinder body when the radar assembly is installed in the hydraulic cylinder head.

Implementation C2 is the radar assembly of C1, the housing further comprising one or more recesses, and the dielectric lens further comprising one or more circumferential grooves, each recess from the one or more recesses of the sensor housing containing a shape that fits to the one or more circumferential grooves of the dielectric lens.

Implementation C3 is the radar assembly of any of implementations C1-C2, wherein the dielectric lens is configured to be inserted into the housing by sliding the one or more circumferential grooves of the dielectric lens into the one or more recesses of the sensor housing.

Implementation C4 is the radar assembly of any of implementations C1-C3, wherein the housing comprises one or more clamping mechanisms configured to hold the one or more circumferential grooves of the dielectric lens into the one or more recesses of the sensor housing.

1. A hydraulic cylinder assembly comprising:
a cylinder body;
a piston configured to slide within an interior of the cylinder body;
a cylinder head coupled to a first end of the cylinder body, the cylinder head comprising a cavity and a bore that extends between the cavity and the interior of the cylinder body along a longitudinal axis;
a radar sensing unit disposed within the cavity of the cylinder head, the radar sensing unit comprising a radar signal emitter and a radar signal detector oriented respectively to emit radar signals through the bore into the interior of the cylinder body and to detect reflected radar signals from the interior of the cylinder body indicative of a position of the piston; and
a dielectric lens between the radar sensing unit and the interior of the cylinder body, the dielectric lens having a convex side facing the radar sensing unit and a planar side opposite the convex side facing the interior of the cylinder body.

2. The hydraulic cylinder assembly of claim 1, wherein the bore that extends between the cavity and the interior of the cylinder body along the longitudinal axis is an axial bore for insertion of the dielectric lens, and wherein the cavity is a radial bore for insertion of the radar sensing unit.

3. The hydraulic cylinder assembly of claim 1, wherein the convex side of the dielectric lens is adjacent to a first medium characterized by a first dielectric constant and the planar side of the dielectric lens is adjacent to a second medium characterized by a second dielectric constant.

4. The hydraulic cylinder assembly of claim 3, wherein the first medium is air and the second medium is a hydraulic fluid.

5. The hydraulic cylinder assembly of claim 1, wherein the radar sensing unit comprises one or more radar sensors configured to transmit and receive radio frequency (RF) signals.

6. The hydraulic cylinder assembly of claim 1, wherein the dielectric lens comprises polyether ether ketone (PEEK) material.

7. The hydraulic cylinder assembly of claim 1, wherein the radar signal emitter is configured to emit a transmit beam along a transmit beam path between the radar signal emitter and the dielectric lens, wherein the transmit beam enters the dielectric lens at a first incident angle at the convex side of the dielectric lens and the dielectric lens causes the transmit beam to refract at a second incident angle, the second incident angle allowing the transmit beam to exit the dielectric lens along an axis substantially parallel to a longitudinal center axis of the dielectric lens.

8. The hydraulic cylinder assembly of claim 1, wherein the dielectric lens is configured to refract a receive beam along a receive beam path between the cylinder body and the dielectric lens, wherein the receive beam enters the dielectric lens at a third incident angle at the planar side of the dielectric lens, and the dielectric lens causes the receive beam to refract at a fourth incident angle, the third incident angle being substantially perpendicular to the planar side of the dielectric lens, and the fourth incident angle allowing the receive beam to exit the dielectric lens at an angle to be received by the radar signal detector.

9. The hydraulic cylinder assembly of claim 1, wherein the radar sensing unit further comprises a sensor housing that encloses the radar sensing unit and wherein the sensor housing comprises an opening to receive the dielectric lens by inserting the dielectric lens into the bore that extends between the cavity and the interior of the cylinder body along the longitudinal axis.

10. The hydraulic cylinder assembly of claim 9, the sensor housing further comprising one or more recesses, and the dielectric lens further comprising one or more circumferential grooves, each recess from the one or more recesses of the sensor housing containing a shape that fits to the one or more circumferential grooves of the dielectric lens.

11. The hydraulic cylinder assembly of claim 10, wherein the dielectric lens is configured to be inserted into the sensor housing by sliding the one or more circumferential grooves of the dielectric lens into the one or more recesses of the sensor housing.

12. The hydraulic cylinder assembly of claim 11, wherein the sensor housing comprises one or more clamping mechanisms configured to hold the one or more circumferential grooves of the dielectric lens into the one or more recesses of the sensor housing.

13. The hydraulic cylinder assembly of claim 1, further comprising a spacer comprising a first end and a second end opposite the first end, the spacer coupled to the cylinder head at the first end and coupled to a sensor housing at the second end, wherein the sensor housing encloses the radar sensing unit.

14. The hydraulic cylinder assembly of claim 13, further comprising a gasket that aids in securing the spacer to the cylinder head, wherein the spacer comprises a cylindrical internal portion comprising at least two grooves, wherein each of the at least two grooves is configured to receive the gasket, wherein the gasket is configured to form a face seal between a first groove from the at least two grooves and an inner surface of the spacer when the gasket is disposed onto the first groove, wherein the gasket is configured to allow rotation of the cylinder head when the gasket is disposed onto a second groove from the at least two grooves, and wherein the second groove is different than the first groove.

15. The hydraulic cylinder assembly of claim 14, wherein the spacer comprises one or more openings disposed through a thickness of the spacer, each of the one or more openings being located at a position on an outer surface of the spacer to provide access to the at least two grooves.

16. The hydraulic cylinder assembly of claim 13, wherein the spacer comprises a connector configured to electrically couple the radar sensing unit to a housing connector of the cylinder head.

17. A hydraulic cylinder assembly comprising:
a cylinder body;
a piston configured to slide within an interior of the cylinder body;
a cylinder head coupled to a first end of the cylinder body, the cylinder head comprising a cavity and a bore that extends between the cavity and the interior of the cylinder body along a longitudinal axis;
a radar sensing unit disposed within the cavity of the cylinder head, the radar sensing unit comprising a radar signal emitter and a radar signal detector oriented respectively to emit radar signals through the bore into the interior of the cylinder body and to detect reflected radar signals from the interior of the cylinder body indicative of a position of the piston;
a removable dielectric lens between the radar sensing unit and the interior of the cylinder body, wherein the removable dielectric lens comprises one or more circumferential grooves; and
a removable sensor housing containing the radar sensing unit and having one or more recesses, each recess from the one or more recesses of the removable sensor housing containing a shape that fits to the one or more circumferential grooves of the removable dielectric lens, wherein the one or more recesses are configured to slidably connect with the one or more circumferential grooves of the removable dielectric lens,
wherein the removable sensor housing can repeatedly position the radar sensing unit a particular distance from the removable dielectric lens.

18. The hydraulic cylinder assembly of claim 17, wherein the removable sensor housing comprises an opening to receive the removable dielectric lens.

19. The hydraulic cylinder assembly of claim 17, wherein the removable dielectric lens is configured to be slidably connected to the removable sensor housing, by placing the one or more circumferential grooves of the removable dielectric lens into the one or more recesses of the removable sensor housing and sliding the one or more circumferential grooves of the removable dielectric lens into the one or more recesses of the removable sensor housing.

20. The hydraulic cylinder assembly of claim 17, wherein the removable sensor housing comprises one or more clamping mechanisms configured to hold the one or more circumferential grooves of the removable dielectric lens into the one or more recesses of the removable sensor housing.
